(19) United States
(12) Patent Application Publication
(10) Pub. No.: US 2001/0038218 A1
(43) Pub. Date: Nov. 8, 2001

(54) VEHICLE BED WITH HIDDEN STORAGE HAVING COLLAPSIBLE RAILS AND COLLAPSIBLE SUPPORT STRUCTURES

(76) Inventors: SCOTT CLARE, HAYWARD, CA (US); NEIL G. LONG, HAYWARD, CA (US)

Correspondence Address: SCOTT E. CLARE / NEIL G. LONG, 22874 SUTRO STREET, HAYWARD, CA, 94541, US

(21) Appl. No.: 09/407,038

(22) Filed: Sep. 27, 1999

Related U.S. Application Data
(63) Continuation-in-part of application No. 08/896,392, filed on Jul. 18, 1997, now Pat. No. 5,979,973.
Application No. 08/896,392 is a continuation-in-part of application No. 08/685,678, filed on Jul. 24, 1996, now abandoned.
Application No. 08/685,678 is a continuation-in-part of application No. 08/506,893, filed on Jul. 26, 1995, now Pat. No. 5,567,000.

(51) Int. Cl. B60P 3/00

(52) U.S. Cl. 296/37.6; 296/189

(57) ABSTRACT

A hidden storage system for a truck bed located in the side panels of the bed and constructed such that one viewing the bed side panels cannot easily discern that there is a storage area behind the side panels. The only access to the storage area is via at least one of the side panel hinged sections or one or more sliding compartments. The storage/side panels of the hidden storage system may each be formed as a single modular unit or formed from a storage box with an opening therein secured to a side panel, with at least one hinged section therein. The storage/side panels include a collapsible support rail to prevent rear impact from driving the rail into the truck cab. In addition, a collapsible beam system may be positioned under the bed to prevent damage to any fuel tank under the bed when the bed is impacted from the side. Also, the storage system includes “door-ajar” indicator means for the hinged panel sections or the sliding compartments of the storage system.

### RELATED APPLICATION

This application is a Continuation-In-Part of U.S. application Ser. No. 08/896,392 filed Jul. 18, 1997 which is a Continuation-In-Part of U.S. application Ser. No. 08/685,678 filed Jul. 24, 1996, now abandoned, which is a Continuation-In-Part of U.S. application Ser. No. 08/506,893 filed Jul. 26, 1995, now U.S. Pat. No. 5,567,000 issued Oct. 22, 1996.

### BACKGROUND OF THE INVENTION

The present invention relates to storage systems for vehicles, such as pickup trucks, particularly to hidden storage systems for beds for compact-size, mid-size and full-size pickup trucks, sports utility trucks, trailers, and full-size trucks having side panels, and more particularly to improvements in hidden storage systems involving collapsible rails and collapsible support structures for a hidden storage bed on a conventional pickup, for example, without altering the external appearance of the bed.

Pickup trucks have long been a means for transporting and/or storing tools, materials, etc. for various trades, such as plumbing, electrical, construction, repair, etc. While conventional tool boxes, which generally extend across the pickup bed, are a convenient tool storage approach, such take up a great deal of space and thus reduce the carrying capacity. Also, the conventional pickup beds have been removed and replaced with utility type beds of various types, such as exemplified by U.S. Pat. No. 5,267,773, No. 3,245,713, No. 3,326,595 and No. 2,722,352. In addition, the pickup truck body and/or beds have been modified to provide storage/utility space, such as exemplified by U.S. Pat. No. 4,917,430, No. 4,685,695, No. 4,135,761, No. 3,727,971 and No. 2,978,153.

While these prior storage/utility arrangements have been satisfactory for their intended purpose, such are an attraction for theft as well as having an appearance of a utility bed. Thus, there has been a need for a storage/utility system for truck beds which does not alter the bed's external appearance or significantly reduce the interior size of the bed, thereby reducing the tool theft problem while providing space for hidden storage without significant reduction of the bed's carrying capacity.

This need has been filled by the invention described and claimed in above referenced U.S. Pat. No. 5,567,000 and by U.S. Pat. No. 5,823,598, which involves the conversion or assembly of a vehicle such as a conventional pickup truck bed into a hidden storage bed without altering the external appearance of the bed and without significant reduction in the carrying capacity thereof—a truck with a trunk. This is accomplished by providing storage adjacent the wheel well area and along the length of the bed, and providing the fender/side panel of the bed with a hinge and latch arrangement whereby the fender/side panel can be raised to expose the storage area, or closed and latched to conceal the storage area. The storage area and the fender/side panel of the bed can be formed as a single modular assembly. Thus, the pickup can be used for pleasure or work without the appearance of its storage/utility capability, and can be parked in areas where theft would likely occur from conventional tool boxes or utility beds. Improvements have been made to the hidden storage bed of the above referenced patents, which includes different fender/side panel hinging, lock and latch systems, collapsible support beams, struts for the fender/side panels, and shelving arrangements including slideable shelves. The present invention is primarily directed to collapsible rails for the side panels and to a collapsible beam support system beneath the bed. The hidden storage bed may be constructed of any conventional automotive material including metals, composites, fiberglass or combinations of materials.

### SUMMARY OF THE INVENTION

It is an object of the present invention to provide a hidden storage system for a vehicle bed, such as a conventional pickup truck bed, without substantially altering the external appearance of the bed, while maintaining the styling of the vehicle.

A further object of the invention is to provide a pickup truck bed, for example, with hidden storage capability without a significant reduction in the carrying capacity thereof.

Another object of the invention is to provide a truck bed with hidden storage capability without significantly altering the external appearance of the bed, and wherein sections of entire side panels of the bed are hinged to enable the side panel or sections thereof to be moved outwardly (raised, lowered or sideways) to expose storage shelves which may be fixed, slideable or adjustable.

Another object of the invention is to provide a vehicle bed with a hidden storage system wherein sections or the entire fender/side panel of the bed is hinged to allow access to the storage area, and the panel or sections are provided with struts and locking and latching means.

Another object of the invention is to reduce theft potential from a storage bed of pickup trucks, etc. and improve the safety of such vehicles when the bed is impacted from the side, by providing collapsible support beams for a hidden storage bed.

Another object of the invention is to provide a standard bed, such as pickup trucks of various sizes, sports utility trucks, trailers or full-size trucks having fender/side panels with a hidden storage system, and wherein the hidden storage system can be provided with a variety of shelving arrangements such that the shelving can be used for storage of small items such as tools or parts, or large items such as skis or golf clubs, etc.

Another object of the invention is to provide a hidden storage system for a truck bed which may contain single modular assemblies on each side, or which may include a collapsible rail on each side to reduce damage due to impact of the bed from the rear.

Other objects and advantages of the invention will become apparent from the following description and accompanying drawings. The invention involves a hidden storage system for beds which are integral with or separate from the cab, such as pickup truck beds that can be installed, for example, in any fleetside, stepside or dual wheel bed without altering the bed's appearance. Any vehicle, including trailers, having side panels can be fabricated or modified to include the storage system. The storage system is installed surrounding the wheel well area of the bed, and uses hinges to open and close sections or the entire fender/side panel of the bed, either upward, downward, or sideways. The fender/side panel is provided with a latching and lock mechanism, which may be electrically or mechanically activated, and may be remotely controlled with an indicator on the dashboard of the cab, and which may also provide a door-ajar warning light or alarm. Since the storage system only involves the area of bed adjacent the wheel wells, it does not significantly reduce the carrying capacity of the bed. By providing a hidden storage system for a pickup truck bed, for example, the potential of theft therefrom is substantially reduced since the unaltered appearance of the bed's external surfaces would not lead one to a realization that it contained tools, etc. The hidden storage system thus provides a truck with a trunk. The hidden storage system can be initially fabricated in the bed, such as on an assembly line using either individual components or modular components, or existing beds can be converted to include the system. The hidden storage system includes struts to hold the side panel up, a collapsible rail for each side panel/storage assembly, and collapsible support beams to improve safety from fuel tank rupture due to a side impact.

### BRIEF DESCRIPTION OF THE DRAWINGS

The accompanying drawings, which are incorporated into and form a part of the disclosure, illustrate embodiments of the hidden storage system and fabrication methods for producing the system and, together with the description, serve to explain the principles of the invention.

FIG. 1 is a view of a side of a pickup truck bed which has been modified to incorporate the storage system under the closed fender/side panel of the bed in accordance with the present invention.

FIG. 2 is an end view of the pickup truck bed of FIG. 1 showing the left fender/side panel open, the right fender/side panel closed, the tailgate open, and the storage boxes and lock mechanism within the bed.

FIG. 3 is a view of an embodiment of the storage system of the FIG. 1 pickup truck bed with the fender/side panel raised to illustrate the storage bin shelves and latch mechanism, and trim panel bins fore and aft of the wheel well.

FIG. 4 is a top view of the FIG. 1 pickup truck bed illustrating the storage boxes and fender/side panels, with the tailgate closed, and collapsible support beams under the bed, with the support beams extending into the fender/side panels, as shown in FIG. 1.

FIG. 5 is a view of a pickup bed similar to FIG. 1 but with the side panel containing three hinged sections, and the hinged sections from the front edge of the bed rearward to include the taillight, and each hinged section is provided with an exposed key and handle arrangement.

FIGS. 6 and 7 are mirror images of opposite sides of a bed similar to FIG. 3 but with three hinged sections and lock/latch mechanisms for each hinged section.

FIG. 8 illustrates an embodiment of a modular storage/side panel assembly having spring-type hinges and wherein the hinged side panel includes the taillight.

FIG. 9 illustrates a modular frame assembly adapted to be mounted to the floor and bulkhead of the bed, and to which the modular assemblies of FIG. 8 or 17 can be mounted.

FIGS. 10 and 11 illustrate embodiments of a collapsible rail for the storage/side panels.

FIG. 12 illustrates another embodiment of the collapsible rail which may be metal or composite material.

FIG. 13 illustrates structural details of an embodiment of the trim panel/wheel well of a storage/side panel module which may be of a metal or a composite, such as in FIGS. 8 and 17.

FIG. 14 schematically illustrates a corner of the storage/side panel assembly showing a hole for a post or support member of a material carrier mounted to the bed.

FIG. 15 illustrates an embodiment of a modular storage/side panel assembly showing a mounting arrangement for a fuel tank filler pipe and a rain gutter.

FIG. 16 illustrates an embodiment of the modular storage/side panel assembly with a rain gutter formed therein, without the fuel tank filler pipe.

FIG. 17 is an exploded view of a modular storage/side panel assembly, similar to FIG. 8, and illustrating the rail beam to which the side panel is hinged, and removable shelves and hinged trim panels.

FIG. 18 illustrates a pickup bed with a modular storage/side panel assembly similar to that of FIGS. 8 and 17 mounted on each side, and wherein the underside of the hinged side panel section includes pockets or bins for retaining materials and illustrates the support members for the side panel section.

FIGS. 19A and 19B illustrate another embodiment of the interior of a modular storage/side panel assembly, with FIG. 19B illustrating a material pocket in an open position.

FIGS. 20-24 illustrate different embodiments of self/compartment arrangements of modular storage/side panel assemblies with liners.

FIG. 25 illustrates an exploded view of a unitized modular fabricated bed with storage/side panel assemblies.

FIG. 26 illustrates a similar embodiment of the bed of FIG. 25, but with three hinged side panel sections.

FIG. 27 is an exploded plan view of the bed of FIG. 25 showing both storage/side panel assemblies with hinged side panel sections, one side having three hinged sections.

FIG. 28 illustrates an exploded view of another embodiment of a modular fabricated hidden storage bed similar to FIG. 25 but with different hinged side panel sections.

FIG. 29 illustrates an exploded view of another embodiment of a modular fabricated hidden storage bed similar to FIG. 25 but with an extended hinged side panel which includes the trim panels such as shown in FIG. 8.

FIGS. 30 and 31 are top views of a hidden storage bed showing different configurations of the hinged panel sections and/or sliding compartments.

FIG. 32 is a view similar to FIG. 7 but illustrating single latch mechanisms for the three hinged sections.

FIG. 33 is a view of a pickup truck bed similar to that of FIG. 7 but with vertically hinged side panel sections and a central sliding compartment.

FIG. 34 illustrates an electrical lock/latch mechanism wherein the hinged side panel section is provided with two latching mechanisms.

FIG. 35 illustrates a truck bed having side panels with inner and outer panels, with hinged doors and support yokes, and has omitted the storage boxes, such as those of FIG. 4, for clarity.

FIG. 36 partially illustrates the truck bed of FIG. 35 with the yokes located fore and aft of the bed floor, and with only one hinged door for simplicity of illustration.

FIG. 37 is a schematic of a remote controlled electrical latch assembly for a truck bed, such as shown in FIG. 3.

FIGS. 38 and 39 schematically illustrate “door-ajar” indicators for the latch mechanisms of the hidden storage system with FIG. 38 showing a two latch system and FIG. 39 showing a three latch system.

### DETAILED DESCRIPTION OF THE INVENTION

The present invention involves improvement of and the fabrication of a hidden storage system for a pickup truck bed, for example, such as described and claimed in above referenced U.S. Pat. No. 5,567,000 and No. 5,823,598, and involves modular assemblies for fabricating a bed to include the hidden system without altering the external appearance of the bed, and without a significant reduction in the carrying capacity of the bed. While the invention is applicable for fleetside, stepside and dual wheel versions of a pickup bed, it can be installed, either by initial assembly or conversion in any type of bed having available space, and utilizing fender/side panels, including trailers. Also, the hidden storage system may be incorporated into vehicles, such as sports utility trucks, wherein the bed is formed integral with the cab. The present invention reduces the theft potential from storage beds by eliminating the appearance of storage in such beds. The invention utilizes lost space adjacent wheel wells of the bed while maintaining the space between the wheel wells. As known, the space between the wheel wells of a conventional pickup truck bed, for example, is about four (4) feet and the conventional pickup truck beds have a length of about eight (8) feet, wherein sheets of 8 ft. by 4 ft. material (such as plywood, etc.) can be carried between the wheel wells. However, the space in front and back of the wheel wells is generally considered lost space for large items until material has been stacked above the height of the wheel wells. Thus, by utilizing the area in front, back, as well as above and below the floor or bed plane of the wheel wells as hidden storage space, the overall storage/carrying capacity of the bed is increased between the outer fender and the inner fender of a stock pickup by removing the inner panel or fender. Also, the space in the side panels below the bed plane and fore and aft of the wheel wells is generally lost space, but which can be utilized by hinging the trim panels to provide access to this space, and forming a compartment, bin or pocket behind the trim panels. Here, the term storage space is defined as that space located above or below the plane of the floor of the bed in which tools (such as vices, saws, parts, skis, golf clubs, etc.) can be stored or mounted for use, and in which shelves can be secured or movably mounted for retaining such tools, parts, skis, etc. Hidden storage is defined as storage within a compartment where external visual appearance reveals no hinges or latches, etc. which may indicate a storage area.

The hidden storage system allows easy-view access for handicapped and short individuals without climbing into the vehicle. Also, one section of the bed may be hinged to provide a work bench.

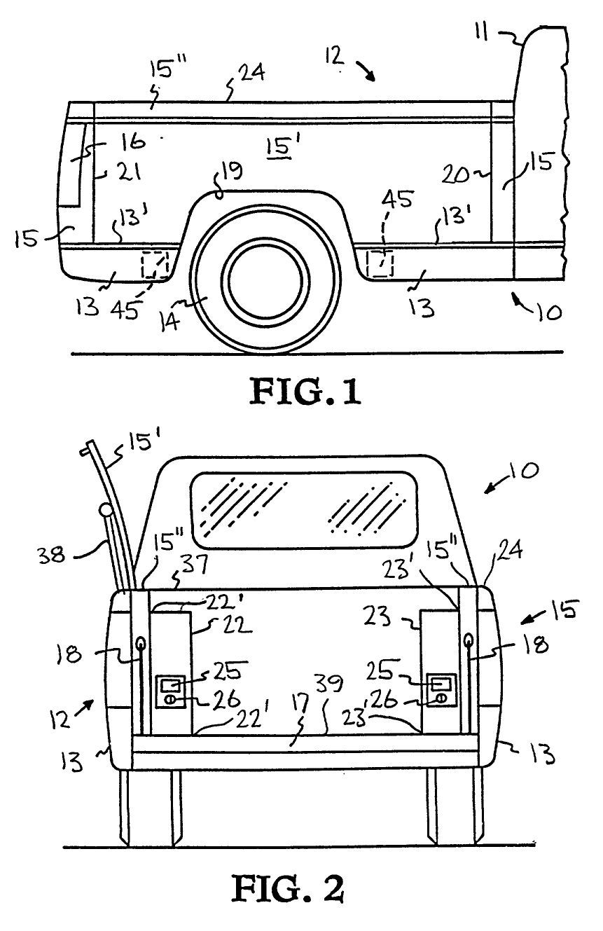

By the present invention, a conventional pickup truck bed, for example, is initially fabricated or converted to a hidden storage bed, whereas the conventional installation of storage/utility beds involve the replacement of the conventional bed, thus the cost of conversion compared to the cost of the conventional bed replacement is substantially less. Basically, the conversion involves cutting each fender/side panel (hereinafter called side panel) vertically in two places, or at the front edge and at the rear post, and along the upper length thereof on an inner surface of the side panel as described in detail hereinafter, disconnecting the lower length of the side panels from the bed frame, hinging the side panel along the upper length, providing braces on the side panels, installing a latching mechanism along the lower length of the side panels, providing a key lock for the latching mechanism, installing a storage structure or box over the wheel wells along each side of the bed, securing shelving to the storage box, and painting the cut areas and the storage box to correspond to the color of the bed. Also, the trim panels may be hinged with a bin located therebehind. Upon completion of the conversion, from a side view, the only difference between the converted bed and a non-converted bed are two vertical lines or small spaces, one just back of the front of the bed and one just forward of the taillight section of the bed where the side panel is cut, as illustrated in FIG. 1. The hinge for each side panel is located on an inner area of the side panel so as not to be exposed to one viewing the bed from an external side position. Thus, one would not readily recognize the modification to the bed and, therefore, those with intent to steal tools, etc. would not recognize the hidden storage arrangement. The hidden storage system utilizes normally lost space located fore and aft of the wheel wells and below the bed or floor plane (i.e., behind the trim panels).

The hidden storage system can be initially fabricated into the bed, as in an assembly line arrangement, wherein the various parts are initially fabricated, then assembled and painted as the bed passes from station to station along an assembly line, as described in greater detail hereinafter. Also, the system can be fabricated/assembled utilizing a modular fabrication/assembly method, as described and claimed in copending U.S. application Ser. No. 08/896,388 filed Jul. 18, 1997 entitled “Hidden Storage/Utility System Modular Fabrication Method”, and Ser. No. 09/183,851 filed Oct. 30, 1998 entitled “Modular Fabrication And Assembly Method for Vehicle Hidden Storage Systems”. The term bed, as recited herein, defines any truck bed or sports utility truck bed or trailer bed of any size which has side panels, and thus excludes passenger vehicles and vans. Also, the term vehicle as used herein defines all sizes of trucks and trailers having side panels, and includes vans and passenger vehicles.

While the drawings, in some instances, show only one side of a bed, for purposes of simplicity, it is to be understood that both sides of the bed may be provided with a hidden storage system located intermediate the side panels.

Referring now to the drawings, FIGS. 1 and 2 illustrate a conventional appearing pickup truck, generally indicated at 10, having a cab 11, bed 12, frame or undercarriage with trim panels 13, and wheels 14. The bed 12 is mounted on the frame or undercarriage, as seen in FIG. 4, and includes side panels 15, a taillight arrangement 16, a hinged tailgate 17 with stop mechanisms 18, and wheel wells 19. However, the bed 12 of FIGS. 1 and 2 has been modified in accordance with the present invention to provide a hinged side panel section 15′, with the only indication of such modification being the cuts, small spaces, or lines 20 and 21 in the side panels 15, as shown in FIG. 1, with the side panel section 15′ being closed. Note that in this embodiment the side panels 15 terminate adjacent the trim panels 13, as indicated by lines 13′.

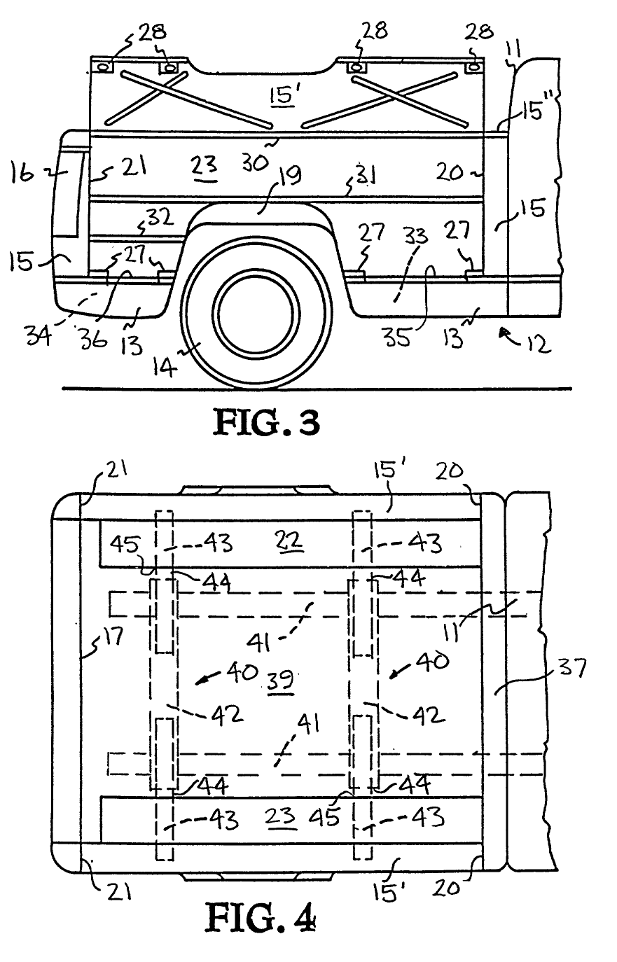

As seen in FIGS. 2, 3 and 4, the hidden storage/utility area is provided by storage or structure boxes 22 and 23 mounted within the bed 12 and over the wheel wells 19, the boxes 22 and 23 being constructed to cover the wheel wells 19, but preferably not extended to the top rail or upper surface 24 of bed 12, as seen in FIG. 2, and terminate in spaced relation to tailgate 17, as seen in FIG. 4. If desired, the boxes may extend to the top rail, but such detracts from the “hidden” feature of the storage system. A latch mechanism 25 is mounted in the rear of each of boxes 22 and 23, as seen in FIG. 2, and is provided with a key lock 26. The latch mechanism 25 includes latch members 27 located in spaced relation along the bed 12, and which cooperate with corresponding latch members 28 in hinged side panel section 15′, as shown in FIG. 3. While not shown, the latch members 27 may be interconnected by a rod or cable which is connected to mechanism 25, which includes a release for members 27, or latch members may be actuated by an electrical solenoid electrically connected to mechanism 25.

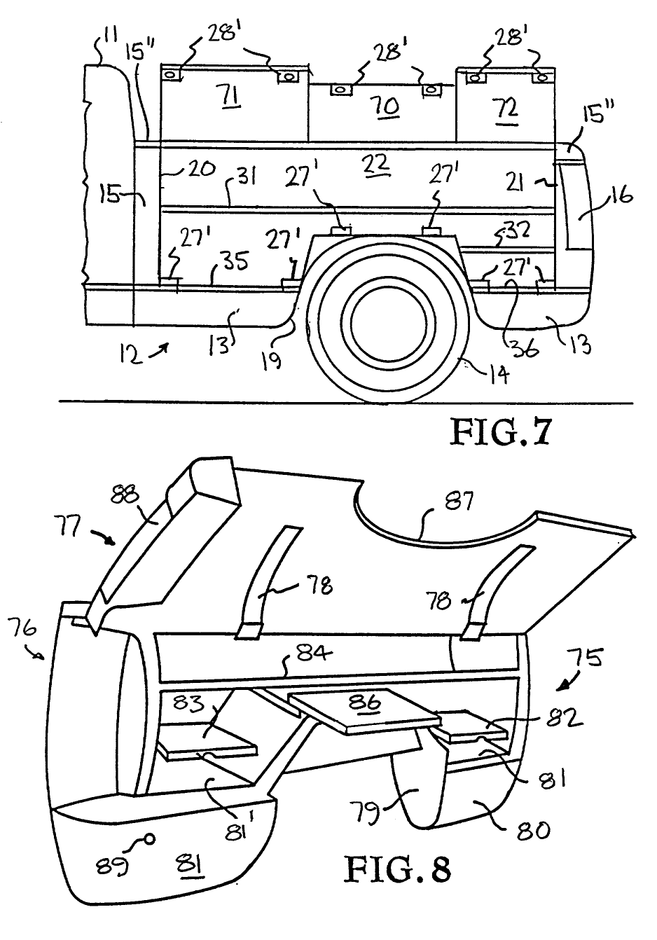

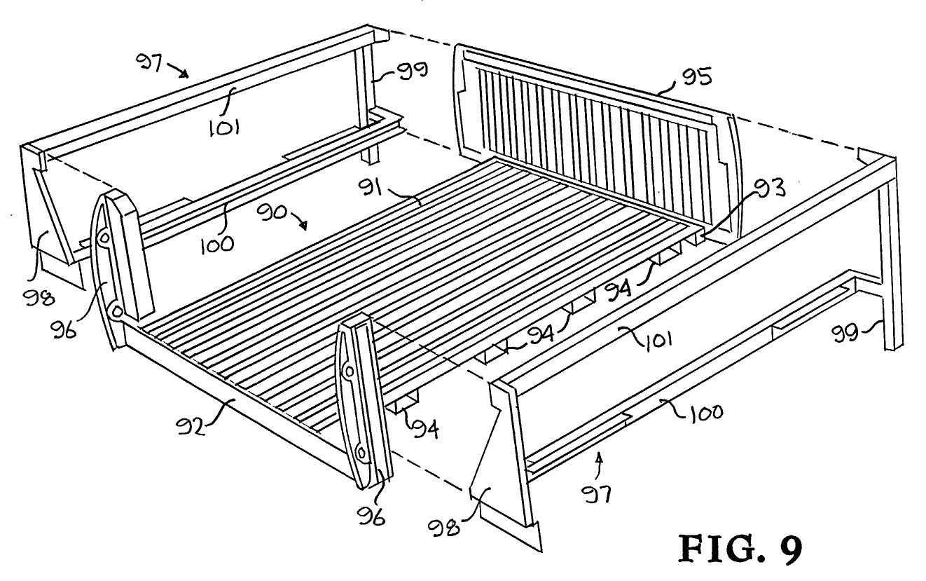

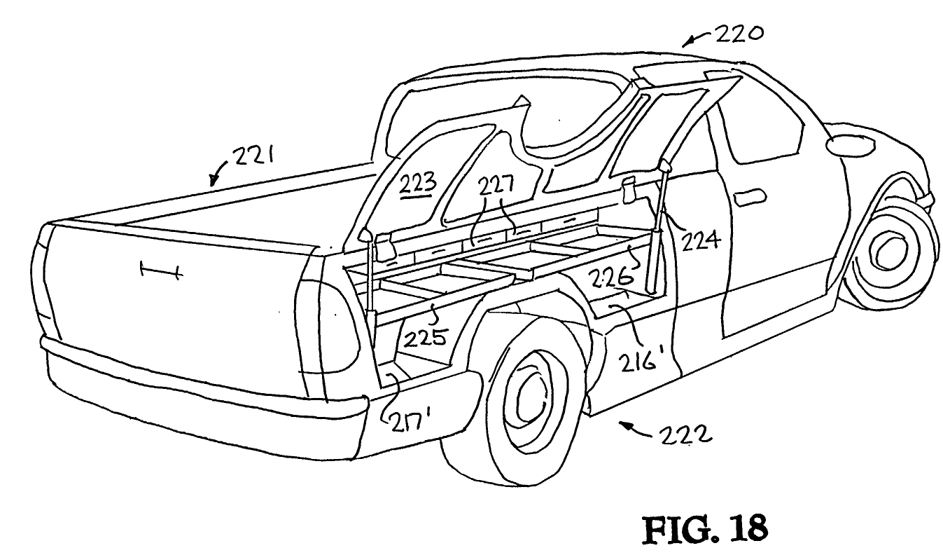

As seen in FIG. 3, the hinged side panel sections 15 are provided with braces 29 and a hinge 30 that may extend the full length thereof. Shelves 31 and 32 are secured to the interior of storage or structure boxes 22 and 23, and the areas forward and aft of the wheel well 19 behind trim panels 13, and form storage bins 33 and 34. Plates or members 35 and 36 cover the storage bins 33 and 34. The hinges 30 are located on the interior of the bed 12 and thus are not visible from the exterior. The hinge 30 may be replaced with spaced spring-type hinges, such as shown in FIGS. 8 and 18.

As seen in FIGS. 2 and 4, the bed 12 includes a bulkhead 37 and, in FIG. 2, a strut assembly 38 is shown for retaining hinged side panel section 15′ in an open position. Depending on the length of the hinged side panel section, more than one strut assembly may be used, as in FIG. 9. The storage boxes 22 and 23 are secured, such as by welding, bonding, etc., to the floor 39 and to the side panel 15, as indicated at 22′ and 23′ in FIG. 2. Each of the side panels 15 include an upper or top support rail 15″ which extends along the length thereof and provides support for the hinged side panel section 15′. The embodiment of FIGS. 1-4 provide a storage system with a walk-ease of placing or retrieving articles without climbing into the bed or reaching over the side panels.

As seen in FIGS. 1 and 4, the bed 12 is provided with a support/safety system which comprises a pair of collapsible beams located beneath the floor 39 and extends into the bins 33 and 34, as shown by dotted lines in FIG. 1. As seen in FIG. 4, the support/safety system includes a pair of collapsible beams 40 mounted on frame members 41 and beneath bed 39. Each collapsible beam 40 comprises a center section 42 and end sections 43, each end section 43 extending into center section 42 and into the bins 33 and 34 of side panels 15 via openings 45. The end sections 43 are, for example, shear bolted or spot welded, as indicated at 44, to center section 42. Upon impact from the side, the shear bolt or spot weld 44 is broken and the end sections 43 collapse into center section 42 and prevent the bed from bending downward, which could rupture a fuel tank located beneath the bed. The beams 40 may be of a tubular, square, rectangular, triangular, etc. cross section. The support/safety system of FIG. 4 is described in greater detail in above referenced copending application Ser. No. 08/896,392.

In another embodiment of the hidden storage system, the cut lines 20 and 21 of FIG. 1 were eliminated and the hinged side panel sections 15′ extend from the forward end of the bed 10 to the taillight arrangement 16, and the only visible cut or line extends downwardly from the taillight arrangement 16 to the lower edge of the hinged side panel. Also, as shown in FIG. 8, the taillight may be included with the hinged panel.

To illustrate the effectiveness of the hidden storage system, a pickup bed was modified to incorporate the hidden storage on only one side using the above described modification of FIG. 1 wherein the hinged side panel extended from the front end or edge of the bed to the taillight assembly, with the only exposed line or cut being the short cut below the taillight assembly. Thousands of people who viewed the modified pickup from both sides of the bed were unable to determine which side incorporated the hidden storage system. Since the storage box, such as box 22 of FIG. 1, terminated below the upper edge of the pickup side panel, it could not be seen from an external side viewing of the bed. This clearly verified the potential the hidden storage system has to eliminate or substantially reduce loss by theft. Further, the pickup containing the hidden storage system of FIG. 1 was parked in a high crime area (where conventional utility beds such as the above referenced patented utility beds were continuously broken into) to determine if theft attempts would be carried out. None were, obviously because those having the intent of theft were unable to recognize that the pickup contained a storage area.

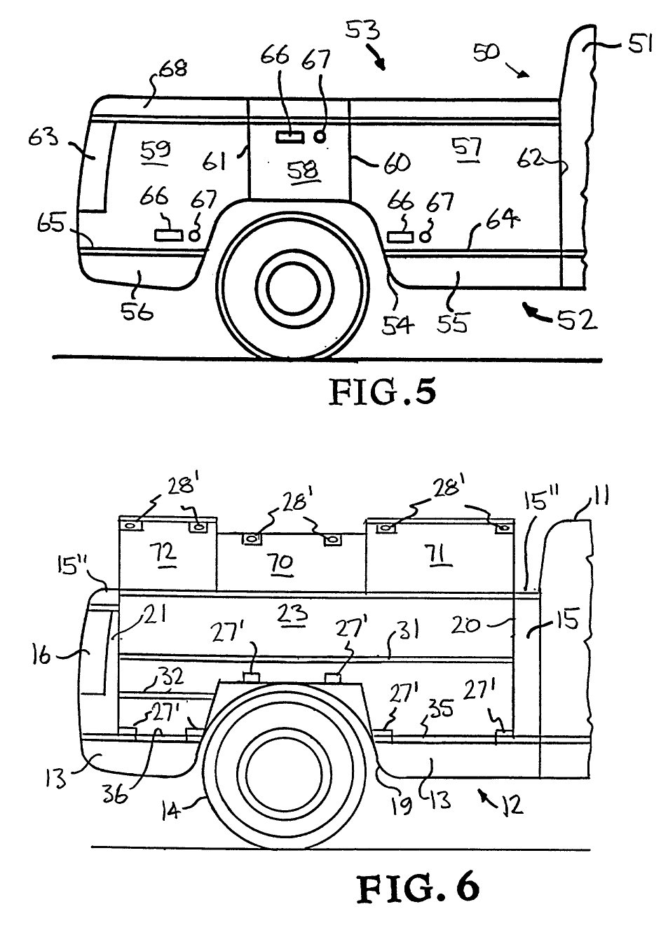

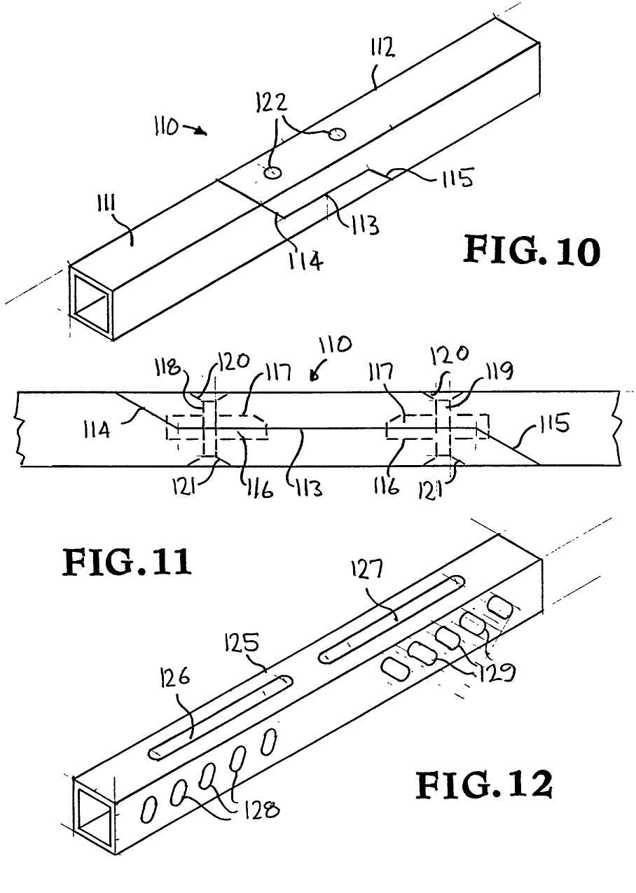

FIG. 5 illustrates another embodiment of a hidden storage system, similar to that of FIGS. 1-4, except that the side panel on each side may include three hinged sections with each hinged section having an exposed key and handle arrangement which, of course, detracts from the advantages of the hidden storage system of FIGS. 1-4. The forward section of the side panel may be hinged as the door in a mini-van and the center section formed as a sliding compartment. As shown, a pickup truck, generally indicated at 50, includes a cab 51 and a bed 52 containing a side panel 53 with a wheel well 54 and trim panels 55 and 56. The side panel 53 is provided with hinged sections 57, 58 and 59, with cut lines 60 and 61 defining the edges of center section 58. Forward section 57 extends from the forward edge 62 of the side panel 53 to cut line 60, aft section 59 extends from cut line 61 to the rear of the side panel and includes the taillight 63. The hinged panel sections 57 and 59 terminate along lines 64 and 65 above trim panels 55 and 56, and panel section 58 terminates at wheel well 54. Each of hinged sections 57-59 include a handle 66 and key slot 67. The hinged side panel sections 57-59 may be hinged by hidden piano-type, spring-type or torsional hinges located on or supported by an upper or top support rail 68 which extends along the length of the bed 52, as shown in detail in FIGS. 10-12 and 17. The trim panels 55 and 56 may be hinged to provide access to the space below the bed or floor plane.

FIGS. 6 and 7 illustrate a pickup truck, generally similar to FIG. 3, except the side panels on each side of the bed have three (3) hinged sections rather than one hinged section on each side, as in FIG. 3. Also, each of the three hinged side panel sections has a pair of latch members in the bed and hinged sections, which may be either mechanically actuated or electrically actuated.

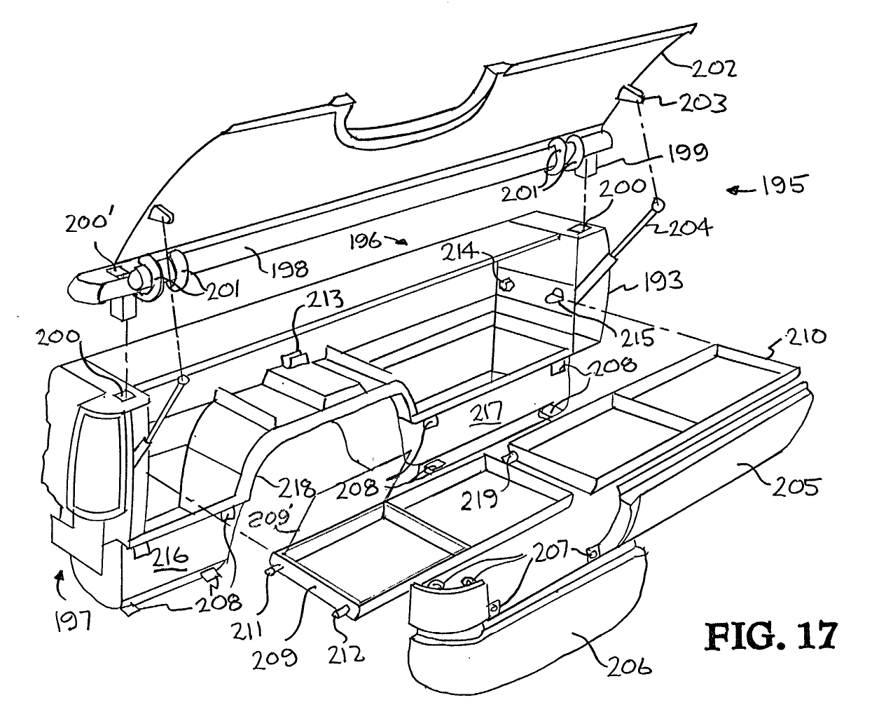

Since the vehicle bed in FIGS. 6 and 7 is substantially the same as the bed of FIG. 3, and since FIG. 7 is a mirror image of FIG. 6, components corresponding to components of FIG. 3 have been given like reference numerals, with the exception of the hinged side panel sections and the latch members. As shown, the bed 12 includes side panels 15 on each side thereof, and each side panel 15 includes three hinged sections 70, 71 and 72, each horizontally hinged so as to enable any of the hinged sections to move outwardly and upwardly to expose interior sections of the storage boxes 22 or 23. If desired, any of the three hinged sections may also be hinged to enable opening downwardly or sideways, and either the front or rear section hinged as in a mini-van such that when open it extends in front of the center section of the side panels. While not shown, the three hinged sections 70, 71 and 72 may each be provided with a strut assembly, such as shown in FIGS. 2 and 17, to retain the hinged sections in an open position, or the hinges may be of a torsion type or a spring type, as shown in FIGS. 8 and 18, which retain the hinged sections in open position. In the embodiment of FIG. 5, like that of FIGS. 1-4, a tonneau or other type of cover may be placed over the bed opening.

As shown in FIGS. 6 and 7, each of the hinged side panel sections 70, 71 and 72 is provided with a latch mechanism for maintaining the hinged sections in closed position. The latch mechanism, as shown in FIGS. 6 and 7, is similar to that illustrated in FIG. 3, and may be actuated as described with respect to FIG. 3. As seen in FIGS. 2 and 3, the latch mechanism, such as shown at 25 in FIG. 2, includes a pair of latch members 27′ secured to the bed 12 adjacent each of the hinged sections 70, 71 and 72, and which cooperate with a corresponding pair of latch members 28′ mounted on each of sections 70, 71 and 72, as seen in FIGS. 6 and 7. While not shown, the latch members 27′ are interconnected by a rod or cable, or interconnected electrically to mechanism 25 which functions to release the members 27′ from members 28′. Such mechanical and electrical lock/latch arrangements are illustrated and described in detail in above referenced copending application Ser. No. 08/896,392.

FIG. 8 illustrates an embodiment of a modularly constructed storage/side panel assembly which may be mounted to the floor and bulkhead of bed 12 on one or both sides of the bed of the FIGS. 1-4 embodiment. The modular storage/side panel assembly, generally indicated at 75, includes a storage section 76 and a hinged side panel section 77 which is hinged to the storage section by a pair of spring-type hinges 78 which retain the side panel section 77 in an open position. Hinges 78 are mounted to an upper support rail, not shown, but similar to that of FIG. 17. Such spring-type hinges are known in the art. Storage section 76 is provided with a wheel well 79 and a pair of trim panels 80 and 81 behind which are located bins or pockets 80′ and 81′ covered by plates 82 and 83. The storage section 76 is also provided with a fixed shelf 84 and a slideable shelf 86, which may be attached as described hereinafter with respect to FIG. 17. The hinged side panel section 77 includes a cut-away wheel well section 87 and includes a taillight assembly 88. A key slot 89 is located in trim panel 81 for actuating a lock mechanism, not shown, for hinged side panel section 77, as described above. Again, the exposed key slot 89 detracts from the “hidden storage” feature of assembly 75, and preferably would be located elsewhere on the bed or in the cab of the vehicle on which assembly 75 is mounted.

FIG. 9 illustrates a partially exploded view of an embodiment of a modular truck bed utilizing frame assemblies to which modular storage/side panel assemblies, such as shown in FIG. 8 and 17, are mounted. As shown, the bed comprises a floor assembly 90 including floor members 91, a rear support member or beam 92, a front support member or beam 93, a plurality of support beams or members 94 intermediate beams 92 and 93, a bulkhead assembly 95 adapted to be secured to the front support beam 93 of floor assembly 90, a pair of upright or vertical assemblies or posts 96 adapted to be mounted to rear support beam 92, and a pair of frame assemblies 97 adapted to be mounted to upright assemblies 96 and to bulkhead assembly 95, each frame assembly including a pair of vertical or upright members 98 and 99 and a pair of horizontal support rails or members 100 and 101, with lower member 100 adapted to be secured to front beam 93 and intermediate beams 94. Upper rail 101 may be of a collapsible type, such as described hereinafter and shown in FIGS. 10-12, to reduce or prevent a rear end impact of rail 101 from being driven through a cab of the truck on which bed 90 is mounted. To complete the truck bed, a tailgate is mounted to upright assemblies or posts 96 and modular storage/side panel assemblies, such as shown in FIGS. 8 and 17, are mounted to the frame assemblies. Thus, with the frame arrangement of FIG. 9, any configured storage section and/or contoured side panel section of a modular storage/side panel assembly, such as shown in FIGS. 8, 17 and 19A-24, for example, may be mounted to the frame assemblies 97 of FIG. 9. Thus, modular storage/side panel assemblies which conform to the desired shape and contour of any truck manufacturer (Ford, General Motors, Dodge, Toyota, etc.), including the dual rear wheel truck beds, may be mounted to a generic type bed assembly, such as shown in FIG. 9, wherein the length, width and height of the assemblies 90, 95, 96 and 97 may be manufactured to fit any size truck bed from the so called ½ ton to the 1½ ton trucks with either single or dual rear wheels. Also, trailers having side panels may be fitted with the hidden storage system.

FIGS. 10 and 11 illustrate an embodiment of a collapsible support rail or beam for the upper rail or rail beam of a bed, such as shown in FIGS. 1, 5 and 17-24, which supports the hinged side panel section or sections as well as the upper rail or beam of the frame assembly 97 of FIG. 9. The purpose of the collapsible support rail or rail beam is to reduce or eliminate the potential of driving the upper rail or beam of a bed through the cab of the truck should that rail or rail beam be impacted from the rear. The embodiments of the collapsible rail or beam 110 is illustrated in FIGS. 10 and 11, with FIG. 10 utilizing a hollow beam or rail and with FIG. 11 being an enlargement of a section of the beam of FIG. 10, and each comprising a pair of members 111 and 112 having adjoining ends of a configuration including a straight central section 113 and tapered end sections 114 and 115. Each member 111 and 112 of FIG. 11 includes mating cut-aways 116 and 117 and through which openings 118 and 119 extend, and each having tapered out ends 120 and 121 through which irrepatriable or shearable members or pins 122 extend. Thus, upon an impact on the end of rear member 111 of sufficient magnitude to shear pins 122, the members 111 and 112 collapse with respect to each other and the impact force on rear member 111 is not transferred to the front member 112 whereby the rail or beam 110 cannot be driven forward into the cab of the truck.

FIG. 12 illustrates another embodiment of a collapsible upper rail of a bed, as exemplified above, and wherein the rail or beam includes cut-away areas designed to cause the beam to collapse upon sufficient end impact. In this embodiment, a rail or beam 125 is provided with a pair of spaced slots 126 and 127 extending therethrough and two sets of oblong openings 128 and 129 which extend through beam 125 transverse to slots 126 and 127, the sets of oblong openings are oriented in opposite direction to one another. The slots 126 and 127 and sets of oblong openings 128 and 129 are designed such that upon an end impact of beam or rail 125, the rail is collapsed either directly or axially sheared to direct the collapse of beam or rail, whereby the force of rear impact is not transferred through the rail or beam 125, preventing same from being driven into the cab of the truck on which the bed is mounted.

The top rails of FIGS. 10-12 may be constructed of formed sheet metal, metal members, composite material, or a combination. The rails are designed to collapse and/shear during rear impact.

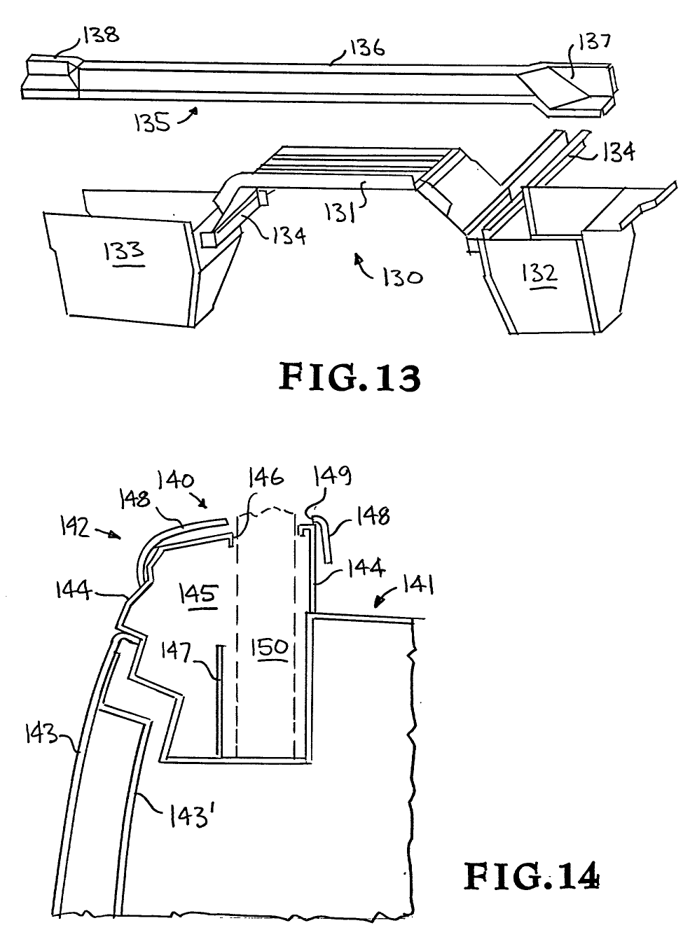

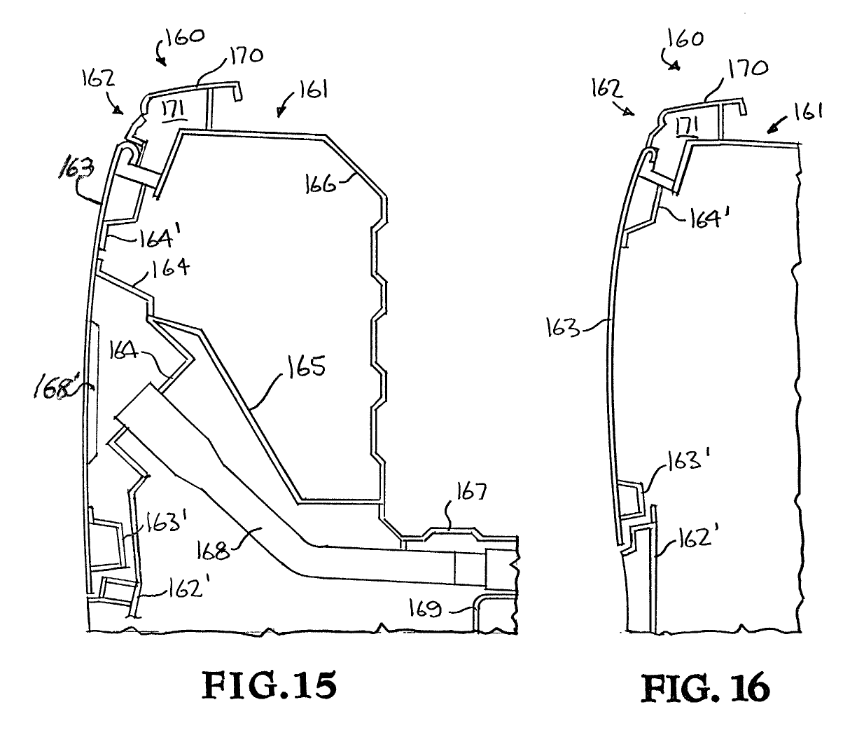

FIG. 13 illustrates an embodiment of two modules or components of a modular storage/side panel assembly comprising the top rail or beam and the wheel well with fore and aft bins, as shown, along with mounting thereof to cross member of a bed floor. As shown, the lower module or assembly 130 includes a wheel well section 131, a forward bin section 132, and an aft bin section 133, with the assembly mounted to bed floor support members 134. The upper module or assembly 135 constitutes the rail or beam and includes a central section 136 to which the side panel section or sections are hinged, and end sections 137 and 138 are adapted to be mounted, for example, to the upper horizontal member of the frame assembly of FIG. 9. End sections 137 and 138 may be configured to include water gutters, as described hereinafter with respect to FIGS. 15 and 16.

FIG. 14 illustrates in cross section a section of a modular storage/side panel assembly with the upper ends thereof being provided with openings for stakes or for vertical supports of an over-cab material carrier, for example. As shown, the modular storage/side panel assembly, generally indicated at 140, includes a storage section, generally indicated at 141, and a side panel section, generally indicated at 142, which includes a hinged side panel 143 having a structural support member 143′. The upper end of the side panel section 142 includes a section 144 forming a chamber 145 which includes an upper opening 146 and in which is located a vertical member 147. A cap or upper rail 148 having an opening 149 extends over the section 144. A member 150, such as a stake or vertical support member for an over-cab material carrier, extends through openings 149 and 146 into chamber 145 adjacent vertical member 147.

FIG. 15 illustrates in cross section a portion of a modular storage/side panel assembly which includes a fuel tank filler tube or pipe and an upper rain gutter. The modular storage/side panel assembly, generally indicated at 160, includes a storage section 161 and a side panel section 162 which includes a hinged panel 163 having a structural support member 163′. The assembly 160 includes interconnected support members 164 and 165 connected to an inner wall 166 of storage area 161 which is connected to a bed floor member 167 for a fuel tank filler tube 168 which is connected to a fuel tank 169 located beneath the bed floor. A hinge leaf 164′ is attached to hinged panel 163, as described in greater detail below. The filler tube 168 is accessed through a flap-type fuel door 168′ in hinged panel 163. The side panel section 162 includes a stop member 162′ for hinged panel 163. A top rail or beam 170 is mounted to member 166 and in contact with hinged panel 163 and defines a channel 171 which functions as a rain or water gutter and drains off the ends of the top rail, keeping water out of the hidden storage compartments.

FIG. 16 illustrates in cross section a section of the modular storage/side panel assembly 160 of FIG. 15, located either fore or aft of the fuel tank filler tube section shown in FIG. 15, and like components are given corresponding reference numerals. The difference in the side panel 162 of FIG. 16 from that of FIG. 15 is basically in the omission in FIG. 16 of support members 164 and 165 while retaining the leaf hinge 164′ for the hinged panel 163 which acts to stop over rotation when the hinged panel is lifted, and which can be constructed of a spring-type material to assist in opening the hinged panel 163 when the lock/latch mechanism therefor, not shown, is released.

FIG. 17 illustrates an exploded view of an embodiment of a modular storage/side panel assembly which can be mounted on both sides of a truck bed and which includes the taillight, and which may be constructed to include a tailgate stop. As shown, the assembly, generally indicated at 195, includes storage section or area 196 and a side panel section 197, which includes a top support rail or bar 198 having protruding or mating members 199, which extend into and are secured in openings 200 in the side panel section 197, as indicated by the dash-dot lines. The mating assembly or members (199-200) can act as stake pockets when an opening 200′ is located in the rail 198. The rail or bar 198 is also provided with hinge assemblies 201 connected to a side panel section 202, with hinged side panel 202 being connected by members 203 to strut assemblies 204 for retaining the side panel section 202 in an open position. The strut assemblies may be replaced with screw-type or hydraulic type openers. A pair of trim panels 205 and 206 are secured by members 207 (only one shown on panel 205) to members 208 on a lower section of the side panel section 197. Trim panels 205 and 206 may be hinged to provide access to the space behind the trim panels. A pair of sliding trays or shelves 209 and 210 which may have covers 209′, each having members or supports 211 and 212, are located on the outer ends. Within the storage section 196 are mounted a center tray support 213 and two sets of outer tray supports 214 and 215 (only one set shown) which cooperate with members or supports 211, and each tray 209 and 210 is provided with an inner end support member 219 (only one shown) which cooperates with center support 213. A pair of storage pockets or bins 216 and 217 are located behind and in front of the wheel well 218 and behind the trim panels 205 and 206. While not shown, each of the pockets or bins 216 and 217 may be provided with a drain/air relief valve assembly, such as illustrated and described in above referenced U.S. Pat. No. 5,823,598.

The components of the modular storage/side panel assemblies of the embodiments of FIGS. 8 and 17, as well as FIGS. 18-24, may be constructed from either composite (e.g., SMC, LPMC, fiberglass, ABS, polyesters, urethanes) or metal. The exceptions, of course, are those components that need steel bolts, latches, hinges, etc. Assembly can be accomplished with mechanical bolting, screwing, etc., welding, brazing, etc., by structural adhesive bonding, or by a combination thereof.

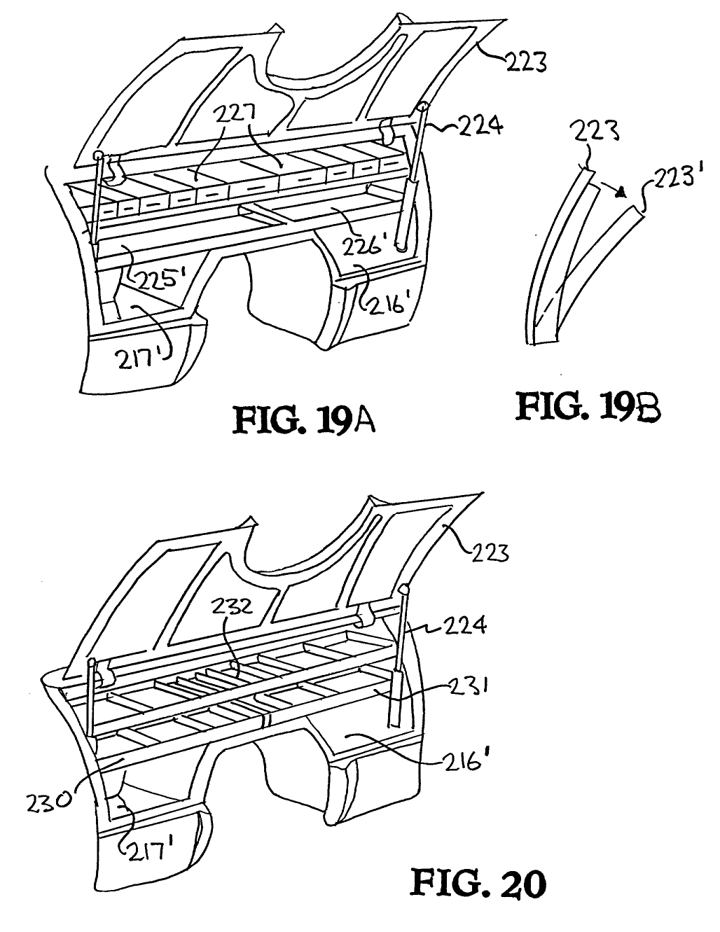

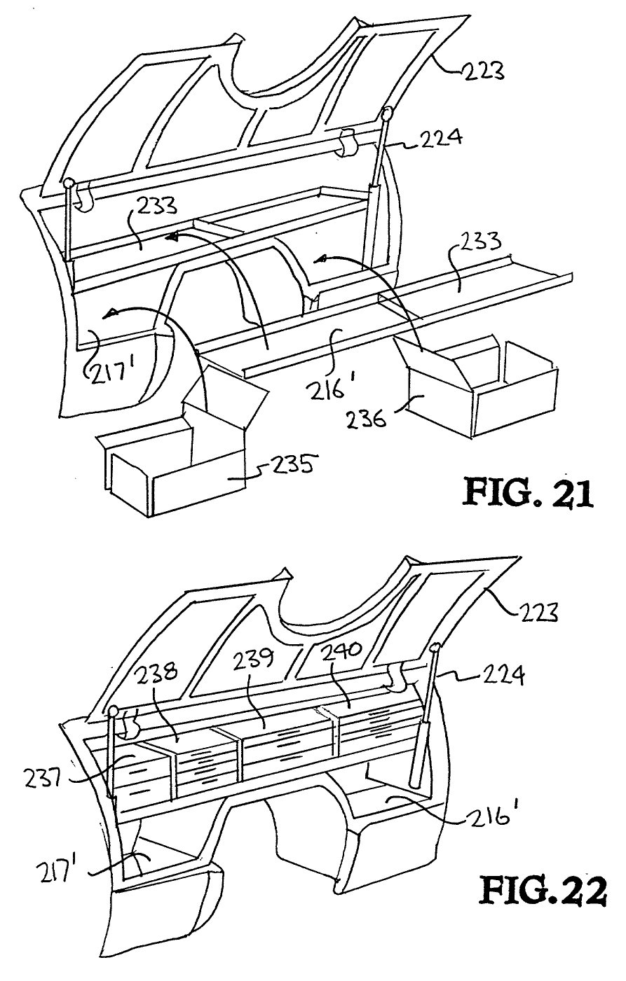

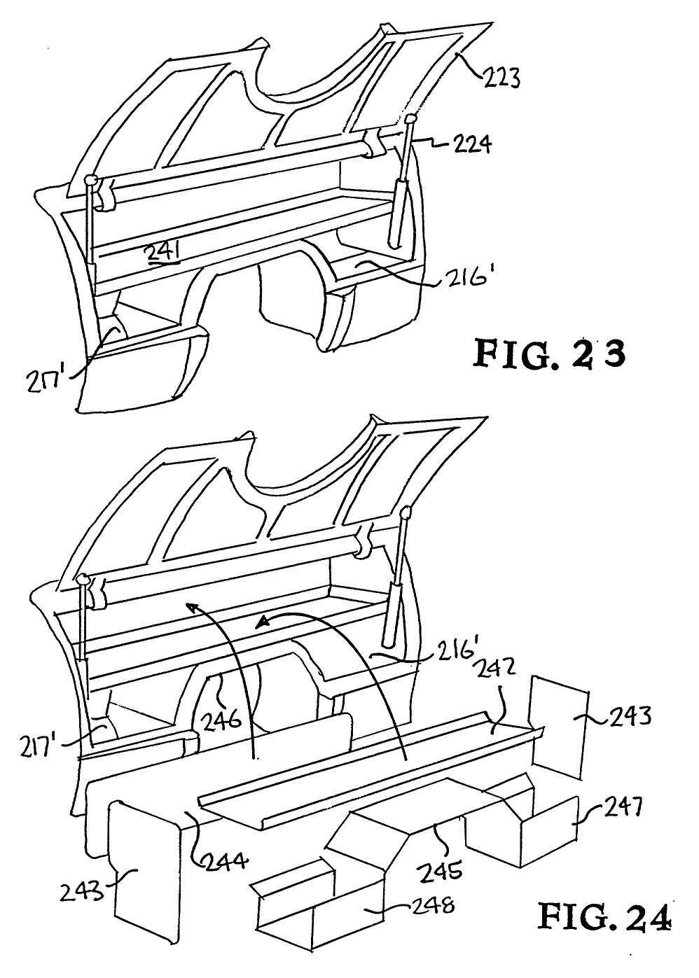

FIGS. 18-24 illustrate a conventional pickup truck bed with different hidden storage systems constructed as modular assemblies for assembly into the bed and which may be located on both sides of the bed. As shown in FIG. 18, the pickup truck, generally indicated at 220, is an extended cab version with the bed, generally indicated at 221, incorporating a hidden storage system, generally indicated at 222, located behind a hinged side panel section 223 of the bed, the hinged side panel section being retained in open position by strut assemblies 224, but can be retained by screw-type or hydraulic-type openers. The storage system, as shown in FIG. 18, includes storage pockets 216′ and 217′, sliding trays 225 and 226, and a series of slideable boxes 227. The storage system of FIG. 19A is generally similar to FIG. 18 except for the configuration of the sliding trays 225′ and 226′ and the number and sizes of the slideable or non-slideable boxes 227′. As seen in FIG. 19B, the hinged side panel may include one or more storage pockets 223′. FIG. 20 differs by the use of two layers of shelves or trays, with the lower layer composed of two sliding trays 230 and 231 with compartments therein and a full length shelf 232 with compartments of various sizes therein. FIG. 21 illustrates a storage arrangement in addition to the storage pockets 216′ and 217′ which utilizes removable components, including a full length shelf 233 or a similar shelf 234 with two compartments and removable boxes 235 and 236 adapted to be located in pockets 216′ and 217′. FIG. 22 illustrates a system that, in addition to the storage pockets 216′ and 217′, uses a series of slideable boxes or trays of different sizes indicated at 237, 238, 239 and 240. The trays, compartment liners, etc. of FIGS. 18-22 may be composed of plastic, rubber compounds, etc. FIG. 23 illustrates a single shelf or open tray 241 that extends the full length of the storage box. FIG. 24 illustrates a full length shelf 242 with side members or compartment liners or insulators 243 and a back member or insulator liner 244, and a single unit 245 which extends over the wheel well 246 and includes pocket sections 247 and 248 that extend into pockets 216′ and 217′. The storage pockets of FIG. 19B may be incorporated into FIGS. 18-24. It is recognized that various other shelving, tray and box arrangements can be formed into the storage/side panel modules, such as shown in FIGS. 3, 8 and 18 and FIGS. 2, 5, 26 and 27 described hereinafter, and that the arrangement of storage/side panel modules on one side may differ from that of the other side of the bed, whereby a user may design the two storage/side panel modules to meet the specific need of that user.

In FIGS. 18-24, the strut assemblies may be replaced with a motorized screw assembly which functions to raise the hinged side panel, retain the panels in open position, and lower and lock the side panels in their closed position.

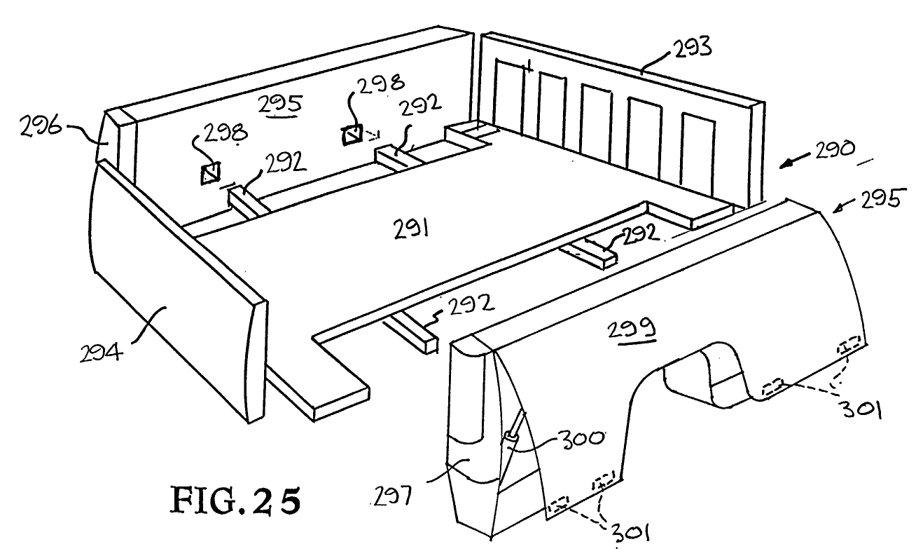

FIG. 25 illustrates another modular assembly approach for the hidden storage bed similar to that of FIGS. 1-4 utilizing the collapsible support members or beams as described above with respect to FIGS. 1-4. As shown schematically in FIG. 25, the bed generally indicated at 290 is basically composed of five modules or assemblies comprising a floor assembly 291 to which collapsible support beams 292 are mounted or connected, a bulkhead assembly 293, a tailgate assembly 294, and a pair of side panel assemblies 295 having connected thereto taillight assemblies 296 and 297, respectively. Side panel assemblies 195 are provided with openings 298 into which collapsible support beams 292 extend, as illustrated in FIG. 1. One of the side panel assemblies 295 is shown with a side section 299 thereof in an open position and retained by a gas lift or strut 300 (only one shown) with latch mechanisms 301 shown in dotted lines. It is understood that the other side panel assembly is provided with a hinged side section such as 299.

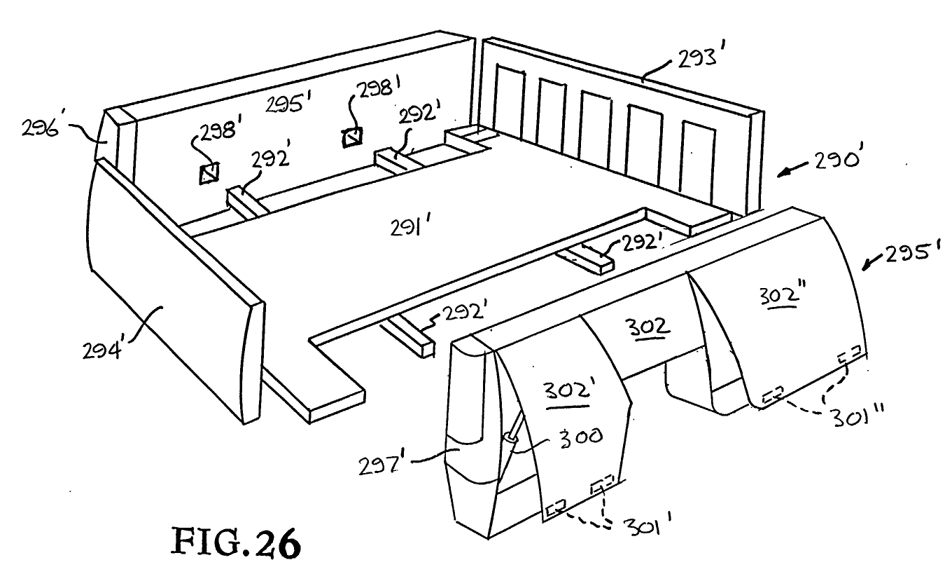

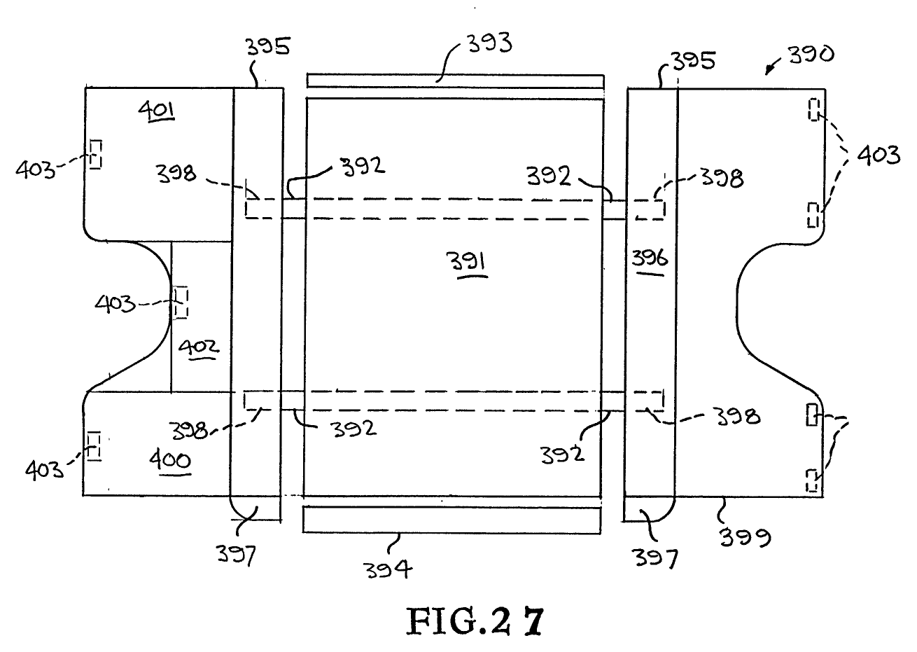

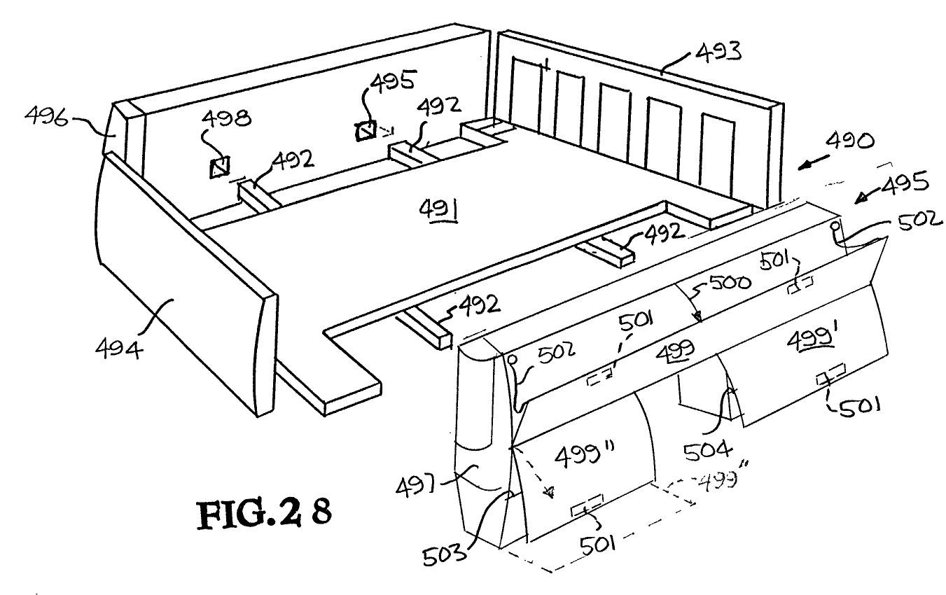

FIG. 26 is a view similar to FIG. 25 except that the side panel 295′ is provided with three hinged sections (302, 302′ and 302″), with section 302 being closed and sections 302′ and 302″ being open and illustrating lock/latch members 301′ in dash lines. Also, section 302 may be hinged to open downward to provide a work table. Other components of FIG. 26 are similar to those of FIG. 25 and have been given corresponding reference numerals.

FIG. 27 is an exploded plan view of the bed of FIG. 25 illustrating the hinged side panels of the storage/side panel assembly in open position. As shown, a bed, generally indicated at 390, comprises a floor section 391 having support members 392 thereunder, a bulkhead section 393, a tailgate section 394, storage/side panel modules 395, and taillight assemblies 397. Each of storage/side panel modules 395 include a storage area 396 with one module having a hinged side panel section 399, the other module having three hinged sections 400, 401 and 402, the ends of support members 392 extending into openings 398 in modules 395, with the hinged side panel sections 399, 400, 401 and 402 having latch mechanisms 403, as shown in dash lines. Note that hinged side panel sections 400, 401 and 402 each have only one latch mechanism 403 while side panel section 399 has two latch mechanisms.

FIG. 28 schematically illustrates another modular assembly similar to FIG. 25, and the bed generally indicated at 490 is composed of five modules comprising a floor assembly 491 to which are mounted collapsible support beams 492, a bulkhead assembly 493, a tailgate assembly 494 and a pair of side panel assemblies 495 having taillight assemblies 496 and 497. Side panel assemblies 495 are provided with openings 498 into which collapsible support beams 492 extend. One of the side panels 495 is shown with an upper side section 499 thereof hinged to be lowered, as indicated by arrow 500, and lower side sections 499′ and 499″ hinged to be raised or lowered. Lower side sections 499′ and 499″ are retained open by strut assemblies, not shown but similar to strut assembly 300 of FIG. 25, and each of side sections 499, 499′ and 499″ are provided with latch mechanisms 501, shown in dotted lines, and with upper side section 499 being retained by cables 502. Hinged sections 499′ and 499″ provide access to bins 503 and 504 located at the bottom of the side panel 495. Side panel 496 may be constructed similar to side panel 495.

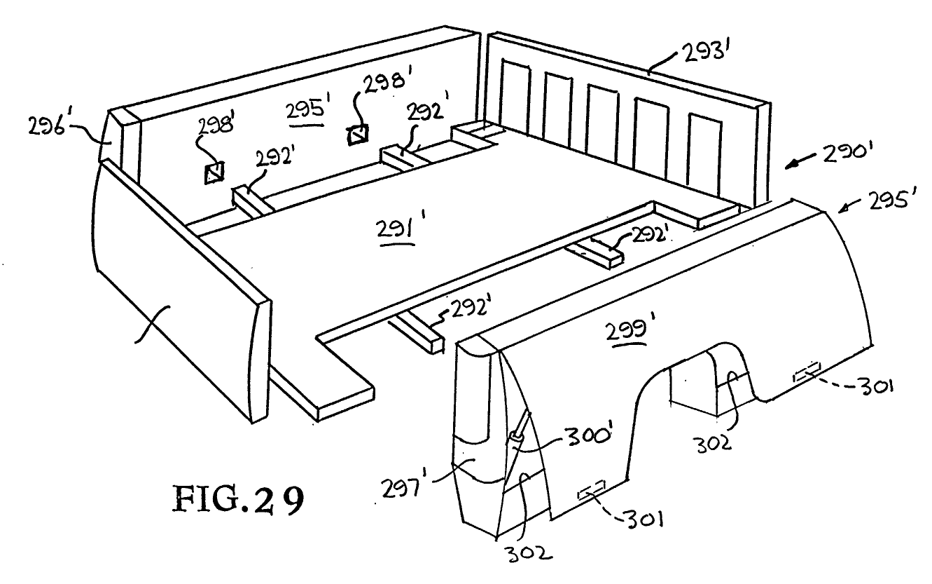

FIG. 29 differs from FIGS. 25 and 29 by the entire side of the bed being hinged, with the hinged side panel sections also covering the trim panels located fore and aft of the wheel wells. The corresponding components of FIGS. 25 and 29 are given similar reference numerals. As shown, the bed 290′ is composed of a floor assembly 291′ with collapsible support beams 292′ mounted thereunder, a bulkhead assembly 293′, a tailgate assembly 294′ and a pair of side panel assemblies 295′ having taillight assemblies 296′ and 297′ mounted thereto. Side panel assemblies 295′ are provided with openings 298′ into which ends of beams 292′ extend. The side panel assemblies 295′ are each provided with a hinged panel section 299′ which extends downward and replaces the conventional trim panels as shown at 13 in FIG. 1, for example. The hinged panel section 299′ may be retained open by one or more strut assemlies 300′ (only one shown) and may be retained in a closed position by latch members 301′, shown in dotted lines. The strut assemby 300′ may be replaced with a screw type or hydraulic type opening, retaining, and closing mechanism. Located behind the lower ends of hinged panel section 299 are a pair of bins 302 which are normally located behind the trim panels.

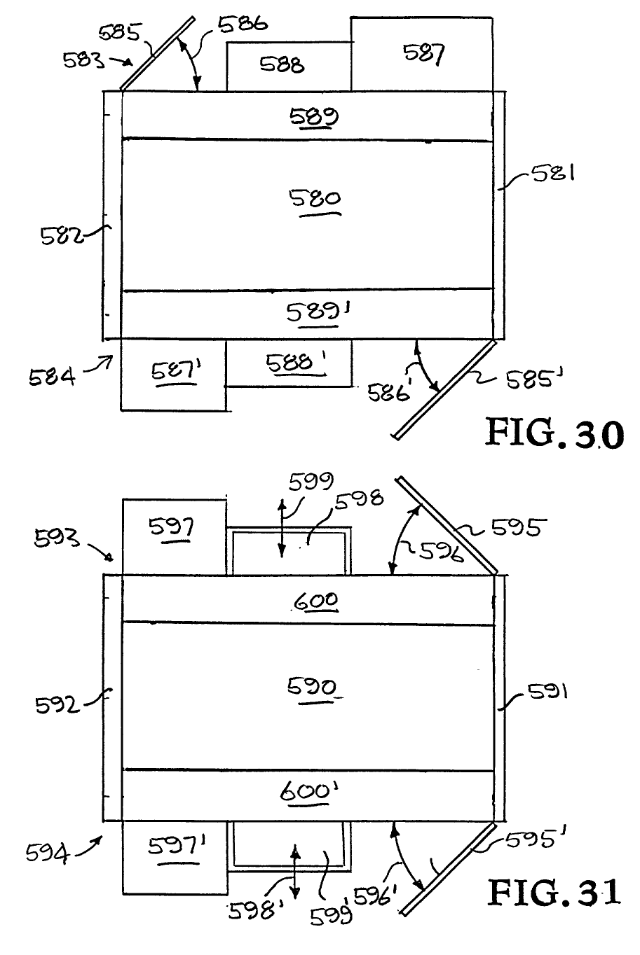

FIG. 30 illustrates a top view of a truck bed having a hidden storage system and which includes both horizontally and vertically hinged side panel sections, each side having a different hinged section arrangement. The bed includes a floor 580, a bulkhead 581, a tailgate 582, and side panels 583 and 584. Side panel 583 includes three hinged sections, each shown open, with section 585 being hinged vertically to open sideways, as indicated by arrow 586, and sections 587 and 588 being hinged horizontally to open upward or downward. For example, center section 588 may open downward to form a work table or work surface. Side panel 584 includes three hinged sections 585′, 587′ and 588′, with vertically hinged section 585′, as indicated by arrow 586′, being located adjacent the bulkhead 581 rather than the tailgate 582. The sections 587′ and 588′ may be hinged to open upward or downward, and section 588′ may open downward to provide a work table. The side panels 583 and 584 each include a storage area or box, indicated at 589 and 589″, which extend along the length of the floor 580, and the only access to the boxes 589 and 589′ is via the hinged sections of the side panels.

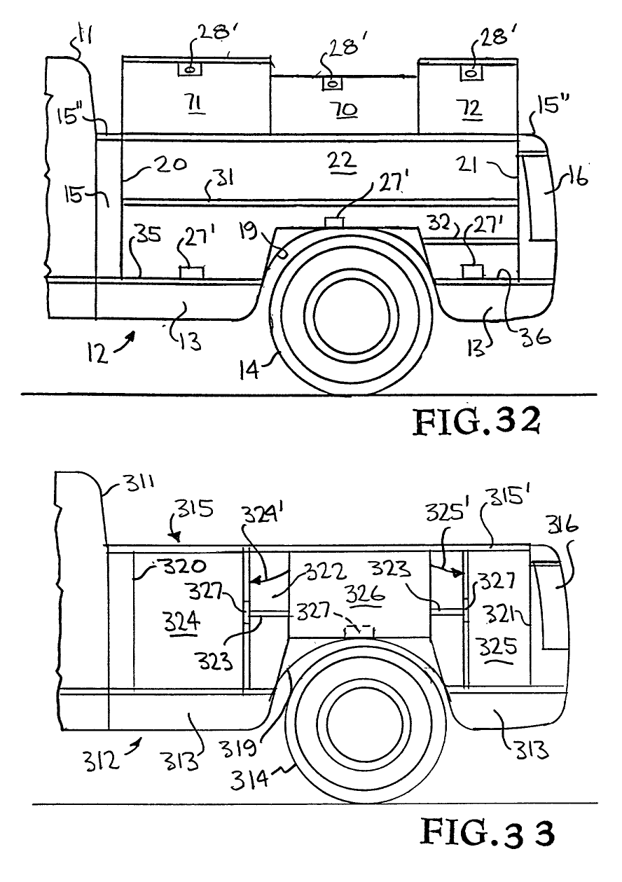

FIG. 31 illustrates an embodiment of a bed similar to FIG. 30 except for the arrangement of the hinged section and that the middle sections are not hinged but comprise a sliding compartment. As shown, the bed comprises a floor 590, a bulkhead 591, a tailgate 592 and two side panel assemblies 593 and 594. Side panel assembly 593 has two hinged sections 595 and 597, with section 593 hinged vertically, as indicated by arrow 596, while the center section 598 of side panel 593 is a sliding compartment, as indicated by arrow 599. Side panel assembly 594 is provided with similar sections as those of assembly 593 and are indicated at 595′, 597′ and 598′, with section 595′ being hinged to open sideways, as indicated by arrow 596′, section 597′ being hinged horizontally to open upward or downward, and section 598′ comprising a sliding compartment, as indicated by arrow 599′. The side panel assemblies 593 and 594 have a storage area or box, indicated at 600 and 600′ respectively.

The storage areas of the side panel assemblies of FIGS. 30 and 31 may be formed as described above with respect to the embodiments of FIGS. 1-4 and 5 or as a modular assembly as described above with respect to FIGS. 8 and 17-27. In the FIGS. 1-4 and 5 embodiments, the storage areas comprise storage boxes secured to the side panel and the floor, while in the embodiments of FIGS. 8 and 17-27, the storage area is fabricated as a portion of the side panel assembly, such as by molds.

FIG. 32 is a view similar to FIG. 7, with the only difference being in the use of single latch mechanisms for the hinged side panel sections. Accordingly, corresponding components are given identical reference numerals. The latch mechanism and hinged side panel sections may be incorporated on both sides of the bed.

FIG. 33 is a view similar to FIG. 7 except that the two end side panel sections are hinged vertically to open sideways and the center side panel section (over the wheel well) comprises a sliding compartment. Corresponding components have corresponding reference numerals. As shown, a pickup truck includes a cab 311 having a bed 312 which includes trim panels 313 located fore and aft of wheel 314, two side panels 315 (only one shown) which include taillight 316, with a top rail 315′ and a wheel well 319 formed in the side panels. Side panels 315 each include a storage area 322, such as formed as a storage box or a portion of a module which includes the side panel 315 and includes shelves 323 and 323′. Each side panel 315 includes three sections located intermediate cut lines 320 and 322, the front section 324 and rear section 325 are hinged vertically to enable sections 324 and 325 to open sideways, as shown by arrows 324′ ad 325′. The center section 326 located above the wheel well 319 comprises a sliding compartment similar to compartments 598-598′ of FIG. 31. Each section 324, 325 and 326 is provided with at least one latch mechanism 327, shown in dotted lines.

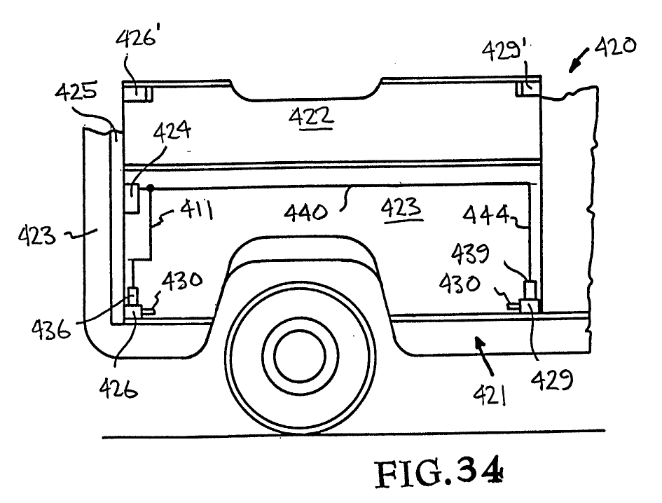

FIG. 34 illustrates a pickup truck with a bed having a hidden storage system therein, generally similar to FIG. 3, and illustrates an electrical latch/lock mechanism. In FIG. 34, the rear end of the storage box is spaced from the tailgate to enable activation of the latch/lock mechanism without lowering the tailgate. As shown, the pickup truck 420 includes a bed 421 with a tailgate 423 with a hidden storage system located in each side panel assembly and spaced from tailgate 423 by a space 425. Only one side panel assembly is shown having a hinged side panel 422 which covers and uncovers the storage area, but both side panels may be similarly formed. The hinged side panel 422 is secured by a latch/lock mechanism having a control 424 connected to cooperating latch mechanisms 426-426′ and 429-429′ having movable member 430. The control 424 is connected via solenoids 436 and 439 via electrical leads or wires 440, 441 and 444. Control 424 may be push button or key activate, or remotely controlled. If desired, the latch/lock mechanism can be simplified by using a single mechanism, such as 426-426′, 431 and 436 located above the wheel well of the bed 421. While only shown on one side of bed 421, it is understood that if each side of the bed is provided with a hidden storage area, the same latch/lock mechanism as shown in FIG. 34 could be utilized.

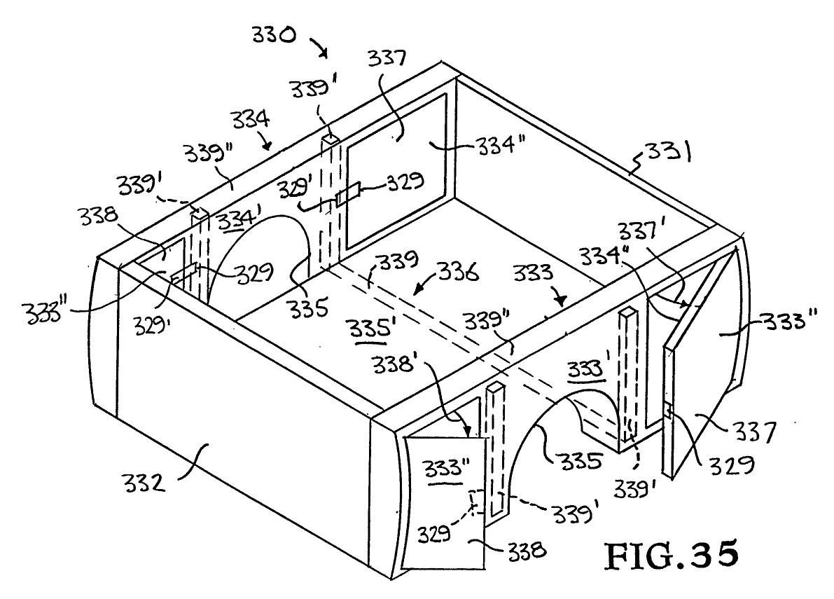

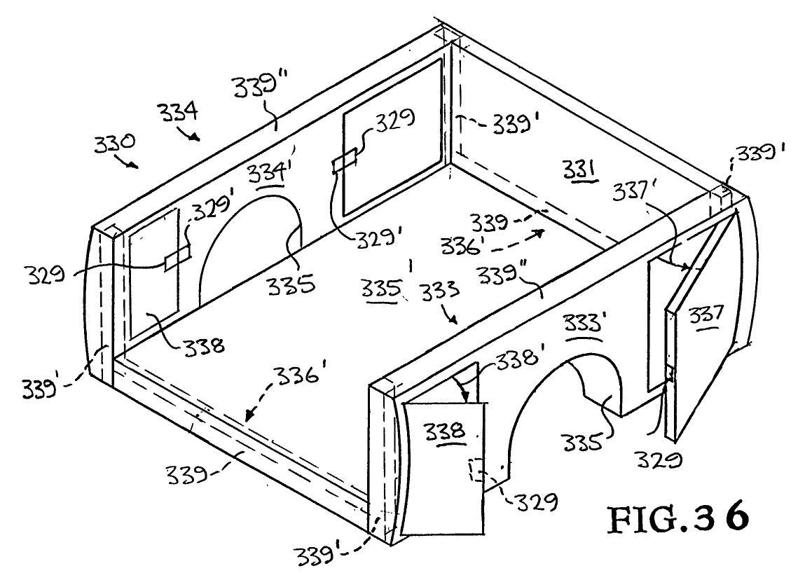

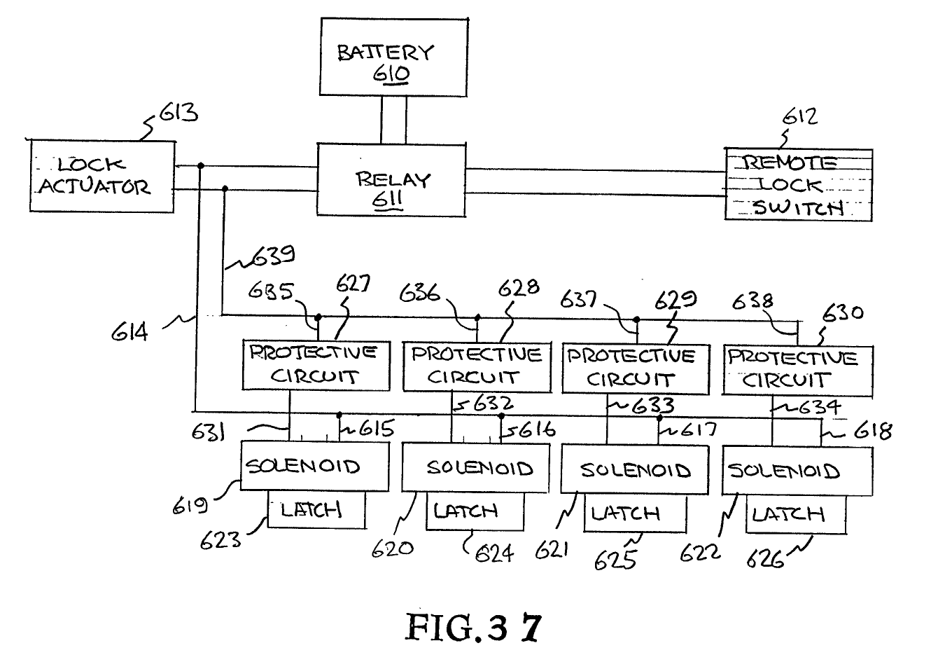

FIG. 35 illustrates a truck bed having side panels with each composed of inner and outer panels, and wherein certain doors are hinged which include both the inner and outer panels, and certain doors are hinged which include only the outer panel, the inner panel having been removed. Storage boxes such as shown in FIGS. 1-4 may be positioned in the bed and adjacent the side panels. Thus, the embodiment provides hidden storage for a bed having a covering top thereon whereby the doors provide side access to the interior of the bed without the need to lower the tailgate. As shown, the bed 330 comprises a bulkhead 331, a tailgate 332, side panels 333 and 334 with yokes or U-shaped support members 336 having sections 339 and 339′ extending beneath a floor 335′ and within the side panels 333 and 334 which include an outer panel 333′ and an inner panel 334′. The bed 330 is provided fore and aft of wheel well 335 with forward doors or hinged sections 337 and rearward doors or hinged sections 338, with forward doors 337 including outer and inner panel sections 333″ and 334″ while rearward doors 338 only include outer panel sections 333″, with sections of inner panel 334′ having been removed adjacent doors 338. While not shown, a sliding compartment may be provided above the wheel wells when the bed is provided with a storage box. Each of the doors 337 and 338 are provided with a latching mechanism indicated at 329 and 329′. The side panels 333 and 334 include top rails 339″ which cover the inner and outer panels 333′ and 334′.

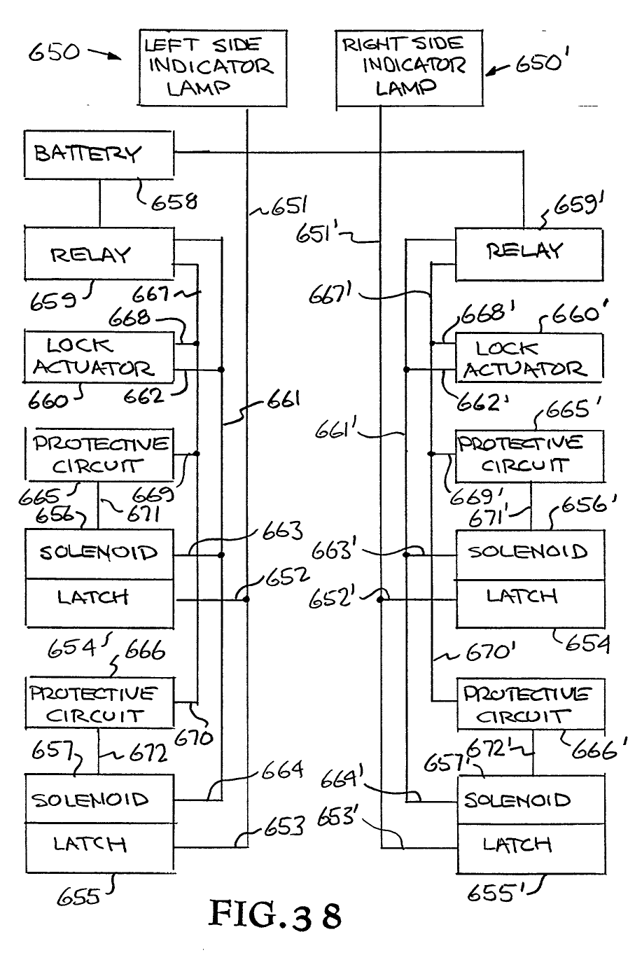

FIG. 36 illustrates a portion of a truck bed similar to FIG. 35 but with the yokes located at the forward and rear areas of the bed. Similar components are given corresponding reference numerals. As shown, the bed 330 has a bulkhead 331 with the tailgate omitted, side panels 333 and 334 of a dual panel construction with a top rail 339″ as in FIG. 35 and in which wheel wells 335 are formed. A pair of yokes or U-shaped members 336′ are mounted adjacent the bulkhead 331 and tailgate 332. The bed of FIG. 36 may be provided with hinged doors as in FIG. 35 of the same or different configuration, and may include a slideable compartment or a hinged panel or door over the wheel well 335 in applications in which a storage area is mounted within the bed and adjacent the side panels. Each side of the bed may be similarly equipped.

FIG. 37 schematically illustrates an electrical remote controlled latch mechanism for a storage system such as shown in FIGS. 3, 6-7 and 17-36. As shown, a truck battery 610 is connected to a relay 611 which is connected to a remote lock switch 612 and a lock actuator 613 which is connected by lead 614 to leads 615, 616, 617 and 618 for solenoids 619, 620, 621 and 622 connected to latchs 623, 624, 625 and 626. Also, solenoids 619-622 are electrically connected to protective circuits 627, 628, 629 and 630 by electrical leads 631, 632, 633 and 634, with protective circuits 627-630 being electrically connected by leads 635, 636, 637, 638 and 639 to a lock actuator 613. Thus, activation of the remote lock switch, which may be of a push-button type, causes each of the latches 623-626 to release, whereby hinged panel sections or sliding compartments in the above described truck bed side panels can then be opened.

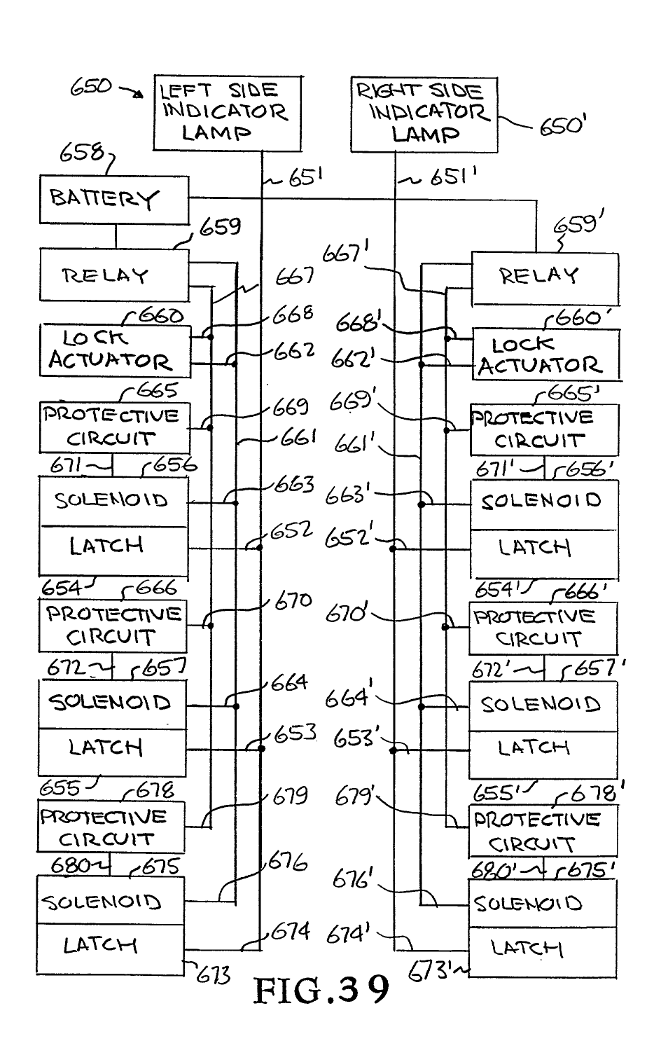

Since the operator of the vehicle or truck on which the hidden storage system bed is mounted should have knowledge as to each of the closures of the hinged side panel sections or sliding compartments of the storage system, a “door-ajar” type indicator system is schematically illustrated in FIGS. 38 and 39. The system of FIG. 38 is for storage systems having two latch mechanisms on each side of the vehicle bed, while the system of FIG. 39 is for three latch mechanisms on each side of the bed. Obviously the system of FIG. 38 can be easily modified to accommodate a single latch on each side of the bed, and the system of FIG. 39 can be readily expanded to accommodate four or more latches on each side of the bed.

FIG. 38 schematically illustrates a “door-ajar” indicator system for the hinged side panel sections of the above described storage system having two latches on the left and right sides of the bed which includes a left side indicator lamp 650 and a right side indicator lamp 650′. Since the components of the right side are the same as those on the left, only the left side is hereinafter described with the various components on the right side being given corresponding reference numerals. As shown, indicator lamp 650 is connected by electrical leads 651, 652 and 653 to latches 654 and 655 which are activated by solenoids 656 and 657 respectively. A battery 658, such as the battery of the truck on which the storage system is mounted, is connected via a relay 659 to a lock actuator 660 and to solenoids 656 and 657 via leads 661, 662, 663 and 664. Relay 659 is also connected to lock actuator 660 and to protective circuits 665 and 666 via leads 667, 668, 669 and 670, with protective cicuits 665 and 666 being connected to solenoids 656 and 657 via leads 671 and 672 respectively. As pointed out above, the right side indicator lamp 650′ is connected to battery 658, and the right side system includes relay 659′, lock actuator 660′, potective circuits 665′ and 666′, solenoids 656′ and 657′, and latches 654′ and 655′, with electrical leads corresponding to those of the left side, as described above.

FIG. 39 illustrates a “door-ajar” indicator lamp system for three (3) latch mechanisms on each side of the bed containg the storage system, such as may be utilized by the storage system of FIGS. 5, 26-28 and 30-33. FIG. 39 is an expanded version of the FIG. 38 indicator system, and corresponding components are given corresponding reference numerals. Since the indicator system is the same as that of FIG. 38, only the additional components are described, these components being latchs 673 and 673′ connected to electrical leads 651 and 651′ by leads 674 and 674′, solenoids 675 and 675′ connected to leads 661 and 661′ by leads 676 and 676′, and protective circuits 678 and 678′ connected to leads 667 and 667′ by leads 679 and 679′, with the protective circuits 678 and 678′ being connected to solenoids 675 and 675′ by leads 680 and 680′.

As can be readily seen, the indicator lamp system of FIG. 39 can be readily expanded to cover four (4) or more latch mechanisms on each side of a storage system bed. Similarly, the system of FIG. 38 can be reduced to cover a single latch mechanism on each side of the storage system bed. Also, the “door-ajar” indicator lamps can be replaced by “door-ajar” indicator alarms, or both lamps and alarms may be utilized such that the operator of the vehicle in which the storage system is mounted will be made aware of the non-closure of any of the hinged panel sectins or the slideable compartments located in the side panels of the bed.

It has thus been shown that the present invention provides a modular storage/side panel assembly which may incorporate a collapsible rail, and the bed on which the modular storage/side panels are mounted may include collapsible support members under the floor and may include upright support assemblies to which the modular storage/side panel assemblies are mounted. The modular storage/side panel assemblies may be manufactured with or modified to include different shelf, tray, compartment, etc. combinations for various desired storage or use needs. The hinged side panel section or sections on one or both sides of the bed include lock/latch mechanisms which may be mechanically or electrically controlled, including remote electrical control with indicators within the cab of the truck to indicate when the hinged sections are unlatched.

While particular embodiments of the storage bed, the modular storage/side panel assemblies, the collapsible bed side panel rail, and the collapsible bed floor support members have been illustrated and described to exemplify and teach the principles of the invention, such are not intended to be limiting. Modifications and changes may become apparent to those skilled in the art, and it is intended that the invention be limited only by the scope of the appended claims.

What is claimed is:

1. In a truck bed having a hidden storage system on at least one side of the bed, the hidden storage system including a storage section and a side panel section having at least one hinged section providing the only access to the storage section, the improvement comprising:
a collapsible rail extending along a length of said side panel section, whereby rear impact on an end of said rail and above a specified magnitude causes said collapsible rail to collapse or shear, preventing the rail from being driven into an associated cab of a truck on which the bed is mounted.

2. The improvement of claim 1, wherein said collapsible rail is constructed of a plurality of interconnected rail sections.

3. The improvement of claim 2, wherein said plurality of interconnected rail sections include at least one interconnecting shearable member.

4. The improvement of claim 3, wherein each of said plurality of interconnected rail sections have an adjacent configured end portion which includes a straight section and a pair of tapered sections located at ends of said straight section.

5. The improvement of claim 4, additionally including at least one set of mating cut-away sections located along said straight section.

6. The improvement of claim 2, wherein said plurality of rail sections are composed of hollow members and constructed of material selected from the group consisting of metal, formed sheet metal, composite material, and combinations thereof.

7. The improvement of claim 1, wherein said collapsible rail comprises a member having a plurality of spaced slots extending therethrough and a plurality of series of elongated openings located adjacent each of said space slots.

8. The improvement of claim 7, wherein each of the series of elongated openings have an elongated portion extending in different directions.

9. The truck bed of claim 1, additionally including a collapsible support system located beneath a floor of the bed and adapted to collapse upon side impact of said bed whereby the floor is prevented from bending downward.

10. The truck bed of claim 1, wherein said storage section and said side panel section comprise a single modular assembly.

11. The truck bed of claim 1, additionally including means for retaining said at least one hinged section in a closed position.

12. The truck bed of claim 10, additionally including a floor assembly, a bulkhead assembly mounted to one end of said floor assembly, a pair of upright assemblies mounted to said floor assembly at opposite corners from said bulkhead assembly, and a pair of frame assemblies each mounted to one of said upright assemblies and to said bulkhead assembly, said single modular assembly being mounted to a frame assembly.

13. The truck bed of claim 12, wherein said floor assembly includes a plurality of cross members, said frame assembly including a pair of spaced horizontal members, a lower member of said horizontal members being mounted to said cross members of said floor assembly.

14. The truck bed of claim 13, wherein an upper member of said horizontal members is collapsible upon end impact of a certain magnitude.

15. In a truck bed having at least one modular storage/side panel assembly forming a hidden storage system and mounted on at least one side of said bed, the improvement comprising:
said at least one modular storage/side panel assembly including a collapsible rail and at least one hinged side panel section mounted to said collapsible rail.

16. The improvement of claim 15, wherein said collapsible rail is composed of a plurality of rail sections interconnected by at least one shearable member.

17. The improvement of claim 15, werein said collapsible rail comprises a member having a plurality of spaced slots and a plurality of sets of elongated openings, each of said plurality of sets of elongated openings being located adjacent one of said slots.

18. The truck bed of claim 15, having a floor assembly and a collapsible support beam structure mounted under said floor, said collapsible support beam structure including a plurality of collapsible beams, each of said collapsible beams including a center section and a pair of end sections mounted in said center section.

19. The improvement of claim 15, wherein said at least one modular storage/side panel assembly includes a plurality of hinged side panel sections, each hinged side panel section including a mechanism for retaining said hinged side panel section closed.

20. The truck bed of claim 15, including a modular storage/side panel assembly mounted on each side of said bed, each assembly including a collapsible rail, each assembly also including at least one hinged side panel section mounted to said collapsible rail.

21. A truck bed composed of connected modular sections, said modular sections comprising:
a floor section,
a bulkhead section,
a tailgate section, and
a pair of side panel sections,
at least one of said side panel sections including a hidden storage area located intermediate an outer panel of said side panel sections and having at least one hinged portion to provide access to said hidden storage area.

22. The truck bed of claim 21, wherein said pair of side panel sections each include a wheel well.

23. The truck bed of claim 21, wherein said pair of side panel sections each include a collapsible upper rail which is constructed to collapse or shear upon end impact above a specified magnitude.

24. The truck bed of claim 21, additionally including non-closure indicator means for said at least one hinged portion.

25. The truck bed of claim 21, additionally includng means for retaining said at least one hinged portion in a closed position, remote controlled means for releasing said at least one hinged portion from its closed position, and indicator means for showing that said at least one hinged portion is not closed.

26. The truck bed of claim 1, additionally including means for maintaining said at least one hinged section in a closed position, means for releasing said at least one hinged section from its closed position, and means for indicating that said at least one hinged section is not in its closed position.
